(19) United States
(12) Patent Application Publication
(10) Pub. No.: US 2018/0218359 A1
(43) Pub. Date: Aug. 2, 2018

(54) MOBILE TERMINAL AND CONTROL METHOD THEREFOR

(71) Applicant: LG ELECTRONICS INC., Seoul (KR)

(72) Inventors: Sujin KIM, Seoul (KR); Sunghye YOON, Seoul (KR)

(73) Assignee: LG ELECTRONICS INC., Seoul (KR)

(21) Appl. No.: 15/746,582

(22) PCT Filed: Sep. 2, 2015
(86) PCT No.: PCT/KR2015/009208

§ 371 Date: Jan. 22, 2018

(30) Foreign Application Priority Data
Jul. 24, 2015 (KR) 10-2015-0105044

(51) Int. Cl. G06Q 20/32; G06Q 20/38; G06Q 20/40; G06Q 20/14; G06Q 20/16; G06Q 20/20

(52) U.S. Cl. CPC G06Q 20/3278; G06Q 20/387; G06Q 20/40; G06Q 20/3223; G06Q 20/16; G06Q 20/20; G06Q 20/14

(57) ABSTRACT

A mobile terminal including an input unit; a display unit; a short-range communication unit; and a controller configured to wirelessly communicate, via the short-range communication unit, with a payment terminal for making a payment using the mobile terminal; display user-settable payment information on the display unit related to making the payment using the mobile terminal; and in response to selection of the user-settable payment information, transmit the selected user-settable payment information to the payment terminal for making the payment via the short-range communication unit.

### CROSS REFERENCE TO THE RELATED APPLICATIONS

This application is the National Phase of PCT International Application No. PCT/KR2015/009208, filed on Sep. 2, 2015, which claims priority under 35 U.S.C. § 119(a) to Patent Application No. 10-2015-0105044, filed in Republic of Korea on Jul. 24, 2015, all of which are hereby expressly incorporated by reference into the present application.

### BACKGROUND OF THE INVENTION

### Field

The present invention relates to a mobile terminal capable of being used in consideration of user convenience, and a method of controlling the same.

### Discussion of the Background

Terminals may be generally classified as mobile/portable terminals or stationary terminals according to their mobility. Mobile terminals may also be classified as handheld terminals or vehicle mounted terminals according to whether or not a user can directly carry the terminal.

As the functions of the mobile terminals are diversified, the mobile terminals may be implemented as multimedia players having functions such as photographing and filming through a camera, voice recording, playback of music or video files, or reception of games or broadcast programs.

Recently, various financial services using terminals have been provided. Fintech is a combination of finance and technology and refers to a service provided by combining finance and IT technology and a company for providing such a service. A payment field of transmitting card information stored in a terminal through the terminal and paying for products or services has been most actively spread as Fintech.

A payment method using Fintech technology through a terminal is conveniently used without a real card and does not expose personal information, that is, has convenience and safety, and thus will be used as a future payment method.

However, payment methods other than payment using card information of a terminal are not yet considered and thus a payment service using a terminal is not yet activated.

### SUMMARY OF THE INVENTION

An object of the present invention is to solve the above-described problems and other problems.

Another object of the present invention is to provide a mobile terminal for facilitating activation of a payment service by processing a variety of selection information such as payment amount control, tip addition, card divisional payment, divisional payment of a plurality of users, country currency selection, memo input, signature input connected with a fingerprint and parking related input, and a method of controlling the same.

Another object of the present invention is to provide a mobile terminal for increasing user convenience by processing payment or selection information using short-range communication such that a user does not need to directly go to a counter, and a method of controlling the same.

Another object of the present invention is to provide a mobile terminal for enabling a user to select and process payment or a variety of information related to payment such that the user actively participates in payment, and a method of controlling the same.

The object of the present invention can be achieved by providing a mobile terminal including an input unit, a display unit, a short-range communication unit for performing short-range wireless communication with a payment terminal, and a controller for receiving payment information and selection information related to payment from the payment terminal through the short-range communication unit, displaying the payment information and the selection information on the display unit, receiving a request command for the selection information from a user through the input unit, and transmitting the received request command to the payment terminal through the short-range communication unit.

In another aspect of the present invention, provided herein is a method of controlling a mobile terminal including an input unit, a display unit and a short-range communication unit for performing short-range wireless communication with a payment terminal. The method includes receiving payment information and selection information related to payment from the payment terminal through the short-range communication unit, displaying the payment information and the selection information on the display unit, receiving a request command of the selection information from a user through the input unit, and transmitting the received request command to the payment terminal through the short-range communication unit.

The mobile terminal and the method of controlling the same according to the present invention have the following effects.

According to at least one of the embodiments of the present invention, it is possible to facilitate activation of a payment service by, at the mobile terminal, processing a variety of selection information other than payment.

According to at least one of the embodiments of the present invention, it is possible to increase user convenience by processing payment or selection information using short-range communication such that a user does not need to directly go to a counter.

According to at least one of the embodiments of the present invention, since a tip is input through the mobile terminal in advance to be processed upon making a payment, the tip need not be given offline.

According to at least one of the embodiments of the present invention, since a necessary memo is written on a payment screen of the mobile terminal, it is possible to improve intimacy through communication between a user and a store owner.

According to at least one of the embodiments of the present invention, since payment is made through fingerprint authentication using the mobile terminal, it is possible to increase card security.

According to at least one of the embodiments of the present invention, since payment is made with optimal currency in consideration of an exchange rate using the mobile terminal, a user may efficiently manage a household budget.

According to at least one of the embodiments of the present invention, since information on exceeding of a payment amount is provided using the mobile terminal, a user may efficiently manage a household budget.

According to at least one of the embodiments of the present invention, since the cellular phone number or business card information of the user is transmitted to the payment terminal such that the user does not need to inform a clerk of the cellular phone number thereof or to input the cellular phone number for an income tax income tax deduction, the user may easily receive the income tax deduction.

According to at least one of the embodiments of the present invention, since a signature is set to be connected to a fingerprint, it is possible to make payment fingerprint authentication without signing a signature.

According to at least one of the embodiments of the present invention, since a parking fee or a valet parking fee is paid upon making payment, the parking fee need not be separately paid.

Additional scope of applicability of the present invention will become apparent from the detailed description below. However, since various changes and modifications within the spirit and scope of the invention will be apparent to those skilled in the art, the detailed description and specific embodiment such as a preferred embodiment of the present invention are to be understood as an example only.

### BRIEF DESCRIPTION OF THE DRAWINGS

FIG. 1 is a block diagram showing a payment system according to an embodiment of the present invention.

FIG. 2 is a block diagram illustrating a mobile terminal related to the present invention.

FIG. 3a is a diagram showing the front side of the mobile terminal.

FIG. 3b is a diagram showing the rear side of the mobile terminal.

FIG. 4 is a flowchart illustrating a method of processing selection information in a payment system according to an embodiment of the present invention.

FIGS. 5a to 5f are diagrams showing screens explaining a method of modifying a payment amount.

FIGS. 6a to 6e are diagrams showing a state of providing different payment related selection information according to a place where a payment terminal is located.

FIGS. 7a to 7c are diagrams showing screens showing a help provision function coupled with a household budget.

FIGS. 8a to 8b and 9a to 9b are diagrams showing screens showing a state of changing currency and a unit of amount of money.

FIGS. 10a to 10d are diagrams showing screens explaining a method of reading a current exchange rate and recommending currency to a user.

FIGS. 11a to 11e are diagrams explaining a partial payment method of paying some of a total payment amount.

FIGS. 12a to 12i are diagrams showing screens explaining a method of divisionally making payment using at least one card.

FIGS. 13a to 13g are diagrams showing screens explaining a state of making payment through account transfer.

FIGS. 14a to 14d are diagrams showing screen explaining a method of giving a tip.

FIGS. 15a and 15b are diagrams showing screens explaining a method of giving a tip when the tip is missed upon payment.

FIGS. 16a to 16c are diagrams showing screens explaining a method of signing a signature through a fingerprint.

FIGS. 17a to 17b are diagrams showing screens explaining a method of registering a signature associated with a fingerprint.

FIGS. 18a to 18d are diagrams showing screens explaining a method of inputting a memo.

FIGS. 19a to 19d are diagrams showing screens explaining a method of inserting a cellular phone number into a receipt.

FIGS. 20a to 20e are diagrams showing screens explaining a method of inserting a business card into a receipt for participation in an event.

FIGS. 21a to 21e are diagrams showing screens explaining a method of paying a parking fee.

FIGS. 22a to 22e are diagrams showing screens explaining a method of selecting various types of receipts.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another. It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

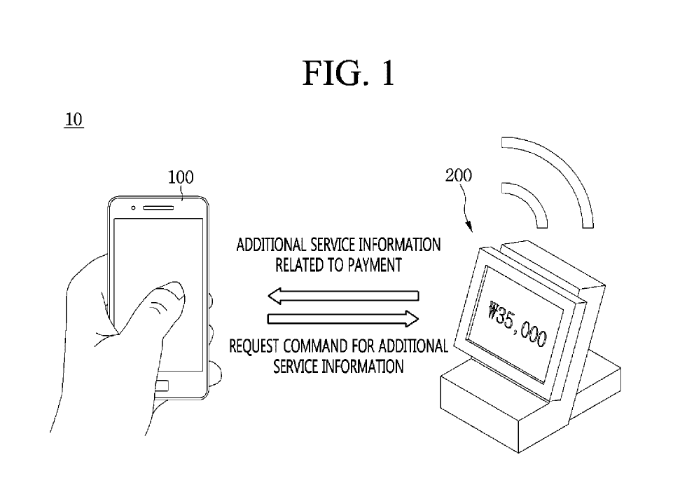

FIG. 1 is a block diagram showing a payment system according to an embodiment of the present invention. Referring to FIG. 1, the payment system 100 according to the embodiment of the present invention includes a mobile terminal 100 and a payment terminal 200. The payment terminal 200 may be a point of sale (POS) terminal, without being limited thereto.

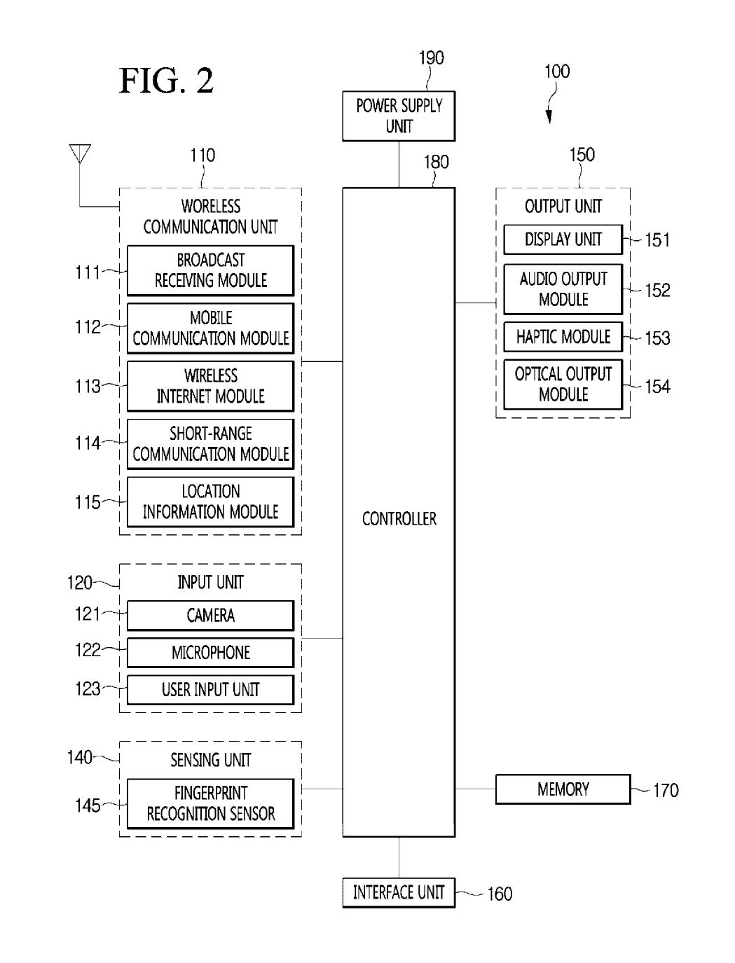

The mobile terminal 100 and the payment terminal 200 may transmit and receive data to and from each other using short-range wireless communication. To this end, the mobile terminal 100 may include a short-range communication module (114 of FIG. 2) and the payment terminal 200 may include a short-range communication module 114.

The payment terminal 200 may provide payment information and selection information related to payment to the mobile terminal 100, and process payment and selection information in response to a request command for the selection information received from the mobile terminal 100. The selection information may include payment amount control, tip addition, card divisional payment, divisional payment of a plurality of users, country currency selection, memo input, signature input connected with fingerprint and parking related input.

The mobile terminal 100 receives and displays the payment information and the selection information related to payment from the payment terminal 200 on the display unit 151 and transmits a request command for the selection information input by a user to the payment terminal 200. The request command of the user may include an input command, an approval command and/or a selection command for the selection command. Therefore, the payment terminal 200 may process a variety of selection information in response to the request command of the user.

Processing of the selection information includes processing of an adjusted payment amount, processing of tip payment and card divisional payment, processing of divisional payment of a plurality of users, processing of country currency selection, memo input/output, processing of signature input connected with a fingerprint, and processing of parking related input.

According to the present invention, the mobile terminal 100 not only provides card approval information to the payment terminal 200 but also implements various services including payment through the mobile terminal 100, thereby remarkably facilitating a payment service of the user.

As a first example, the mobile terminal 100 may adjust, for example, reduce a payment amount received from the payment terminal 200 to bargain with the payment terminal 200 over the payment amount. As a second example, the mobile terminal 100 may input a desired tip amount to process the tip upon making payment, thereby not separately giving the tip offline.

As a third example, the mobile terminal 100 may write a necessary memo on a payment screen, thereby improving intimacy through communication between a user and a store owner. As a fourth example, the mobile terminal 100 may make payment through fingerprint authentication, thereby increasing card security. As a fifth example, the mobile terminal 100 may provide information on exceeding of a payment amount, such that a user efficiently manages a household budget.

As a sixth example, the mobile terminal 100 may make payment with optimal currency in consideration of an exchange rate, such that a user efficiently manages a household budget. As a seventh example, the mobile terminal 100 may enable several persons to divide a payment amount and to make payment. As an eighth example, the mobile terminal 100 may inform a user of whether to exceed a specific card limit to make payment using another card or through account transfer.

As a ninth example, the mobile terminal 100 may enable a user to make payment using several cards thereof. As a tenth example, the mobile terminal 100 may set a signature to be connected to a fingerprint to make payment through fingerprint authentication without signing a signature. As an eleventh example, the mobile terminal 100 may pay a parking fee or a valet parking fee upon making payment, such that the parking fee is not separately paid.

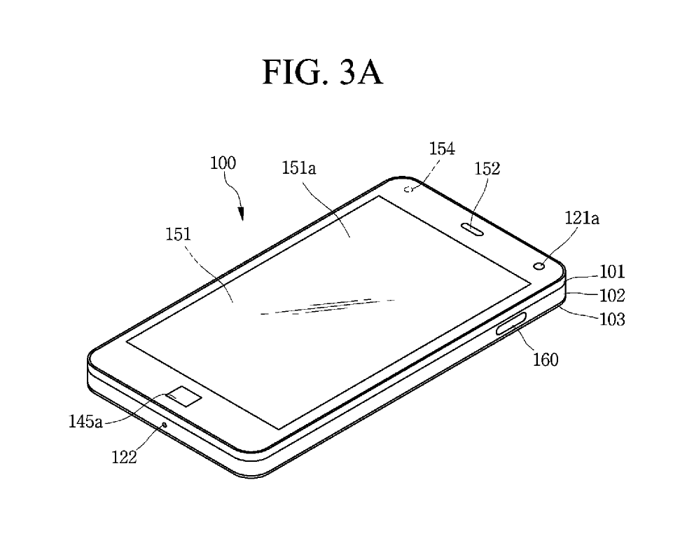

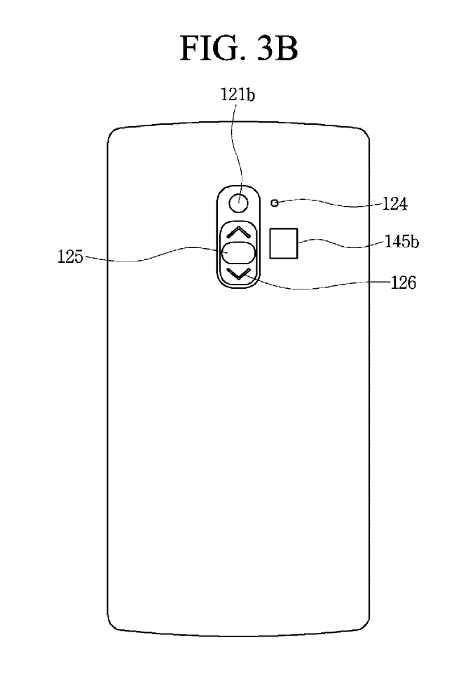

Reference is now made to FIGS. 2-3b, where FIG. 2 is a block diagram of a mobile terminal in accordance with the present disclosure, and FIGS. 3a and 3b are conceptual views of one example of the mobile terminal, viewed from different directions. The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 2, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The broadcast receiving module 111 may mean a server for generating and transmitting a broadcast signal and/or broadcast related information or receiving and transmitting a previously generated broadcast signal and/or broadcast related information to a terminal. The broadcast signal may include a TV broadcast signal, a radio broadcast signal, a data broadcast signal and a combination of the TV broadcast signal or the radio broadcast signal with the data broadcast signal.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

Bluetooth is used in a frequency band of 2400 to 2483.5 MHz. Since Bluetooth uses the same frequency band as several systems, radio frequency interference between systems may occur. In order to prevent radio frequency interference, a frequency hopping method is used. Frequency hopping refers to a method of rapidly hopping between a large number of channels according to a specific pattern to slowly transmit packets. For example, Bluetooth may hop 79 allocated channels 1660 times per second. If such a Bluetooth method is used, data transmission and reception through short-range wireless communication may be performed even when a distance between the mobile terminal 100 and the payment terminal 200 is about several tens of meters. Accordingly, in the present invention, if a Bluetooth type short-range communication module is employed, a user who carries the mobile terminal 100 may make payment or decide selection information using Bluetooth type short-range wireless communication at a current position in a store. Accordingly, it is possible to prevent the user from standing in line to make payment at a counter of a crowded store.

Wi-Fi is wireless LAN technology used for products suitable for various regulations defined in wireless LAN standards (IEEE 802.11b) using a band of 2.4 GHz, and Wireless Ethernet provides a speed of 11 Mbps per second and is available anywhere in a radius of 500 m under optimal conditions.

The location information module 115 is generally configured to detect, calculate, derive or otherwise identify a position of the mobile terminal. As an example, the location information module 115 includes a Global Position System (GPS) module, a Wi-Fi module, or both. The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The first camera 121 can process image frames such as still or moving images obtained by the image sensor in a capture mode or a video call mode. The processed image frames can then be displayed on the display unit 151 or stored in the memory 170.

The microphone 122 is generally implemented to permit audio input to the mobile terminal 100. The audio input can be processed in various manners according to a function being executed in the mobile terminal 100. The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. The sensing unit 140 is typically implemented using one or more sensors configured to sense internal information of the mobile terminal, the surrounding environment of the mobile terminal, user information, and the like. For example, the sensing unit 140 can include a proximity sensor and an illumination sensor.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

A finger scan sensor 145 may recognize the fingerprint of the user. The finger scan sensor 145 may be installed in the front surface and/or rear surface of the mobile terminal 100. As shown in FIG. 3a, a finger scan sensor 145a may be installed at the lower side of the front surface of the mobile terminal 100, without being limited thereto.

A display unit 151 may be provided in the front surface of the mobile terminal 100 to output information. As shown, a window 151a of the display unit 151 may be mounted in a front case 101 to form the front surface of the terminal body along with the front case 101. The front case 101 may be fastened with a rear case 102 and a rear cover 103. Such cases 101, 102 and 103 may be formed by molding synthetic resin or may be formed of metal such as stainless steel (STS), aluminum (Al) or titanium (Ti).

The mobile terminal 100 may include the display unit 151, an audio output unit 152, an optical output module 154, front and rear cameras 121a and 121b, a microphone 122, and an interface unit 160. As shown in FIG. 3b, a finger scan sensor 145b may be installed at one side of the rear surface of the mobile terminal 100. For example, the finger scan sensor 145b may be installed beside a power button 125 installed in the rear surface. For example, the finger scan sensor 145b may be coupled with the power button 125 to perform a finger scan function and a power on/off function, without being limited thereto.

Volume control buttons 126 may be installed above and below the power button 125, the rear camera 121b may be installed above the volume control button 126, and a flash 124 may be installed around the rear camera 121, for example, at the right side of the rear camera 121.

The output unit 150 may generate video, audio or tactile output and include at least one of the display unit 151, the audio output module 152, the haptic module 153 and the optical output module 154. The display unit 151 may have an inter-layered structure or an integrated structure with a touch sensor to realize a touchscreen. The touchscreen may provide an output interface between the mobile terminal 100 and a user, as well as function as the user input unit 123 which provides an input interface between the mobile terminal 100 and the user.

The display unit 151 is configured to output information processed in the mobile terminal 100. For example, the display unit 151 may display execution screen information of an application program running on the mobile terminal 100 or user interface (UI) and graphical user interface (GUI) information in response to the execution screen information.

The audio output module 152 may output audio data received from the wireless communication unit 110 or stored in the memory 170 in a signal reception mode, a call mode, a record mode, a voice recognition mode, and the like. The audio output module 152 may include a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

The interface unit 160 serves as an interface for various types of external devices to be connected with the mobile terminal 100. The interface unit 160 may include wired or wireless headset ports, external power supply ports, wired or wireless data ports, memory card ports, ports for connecting a device having an identification module, audio input/output (I/O) ports, video I/O ports, earphone ports, or the like. In correspondence with connection of an external device to the interface unit 160, the mobile terminal 100 may perform appropriate control related to the connected external device.

The memory 170 can store data supporting various functions of the mobile terminal 100. The memory 170 may store a plurality of application programs or applications executed in the mobile terminal 100 and data and commands for operation of the mobile terminal 100. At least some of such application programs may be downloaded from an external server through wireless communication. In addition, at least some of such application programs may be present in the mobile terminal 100 upon releasing the mobile terminal, for the basic functions (e.g., an incoming call function, an outgoing call function, a message reception function and a message transmission function). Meanwhile, the application programs may be stored in the memory 170 and installed in the mobile terminal 100 to be executed to perform operation (or function) of the mobile terminal 100 by the controller 180.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing connected with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

Some of the components may cooperatively operate in order to implement operation, control or control methods of the mobile terminal according to the below-described embodiments. In addition, operation, control or control methods of the mobile terminal may be implemented on the mobile terminal by executing at least one application program stored in the memory 170.

Hereinafter, embodiments related to a control method implemented in the mobile terminal having the above configuration will be described with reference to the accompanying drawings. It is apparent to those skilled in the art that the present invention may be embodied in specific forms without departing from the spirit and features of the present invention.

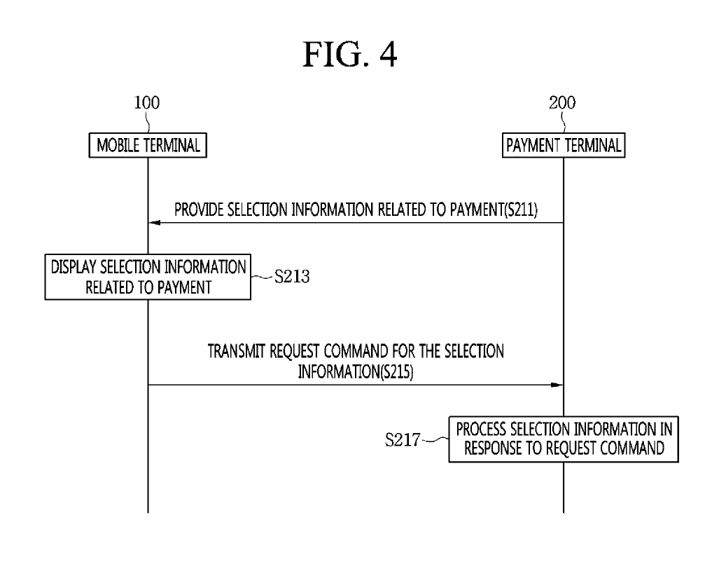

FIG. 4 is a flowchart illustrating a method of processing selection information in a payment system according to an embodiment of the present invention. Referring to FIG. 4, the payment terminal 200 provides payment information and selection information related to payment to the mobile terminal 100 (S211).

When a user carrying the mobile terminal 100 places an order at a restaurant, the order may be input to the payment terminal 200. In this case, the payment terminal 200 may generate and provide the payment information and the selection information related to payment to the mobile terminal 100 through short-range wireless communication. In addition, the payment terminal 200 may display the payment information and the selection information on the screen of the payment terminal 200.

The mobile terminal 100 may receive the payment information and the selection information related to payment from the payment terminal 200 and display the payment information and the selection information related to payment on the display unit 151 (S213). The user may view the payment information and the selection information related to payment received from the payment terminal 200 through the display unit 151 of the mobile terminal 100.

The user may input a request command for approving, selecting and/or inputting necessary selection information based on the payment information and the selection information related to payment displayed on the display unit 151. In this case, the mobile terminal 100 may transmit the request command for the selection information from the user to the payment terminal 200 (S215).

The payment terminal 200 processes the selection information in response to the request command for the selection information (S217). As described above, processing of the selection information includes processing of an adjusted payment amount, processing of tip payment and card divisional payment, processing of divisional payment of a plurality of users, processing of country currency selection, memo input/output, processing of signature input connected with a fingerprint, and processing of parking related input.

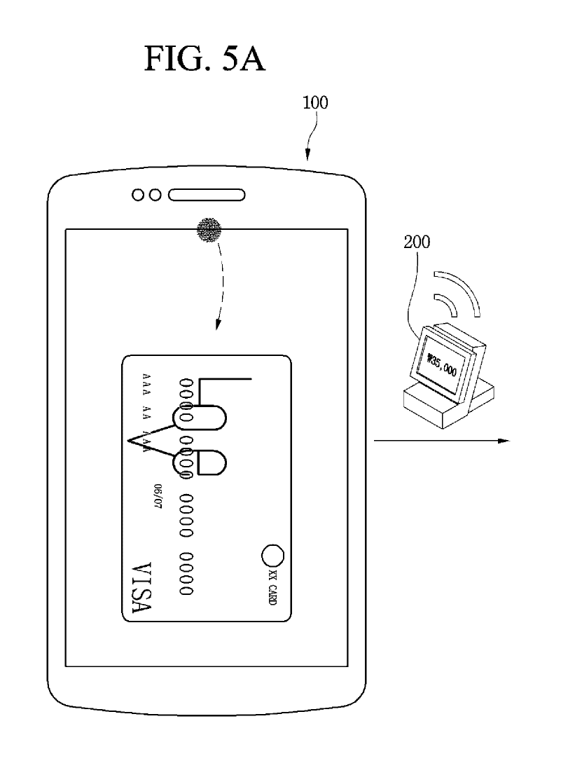

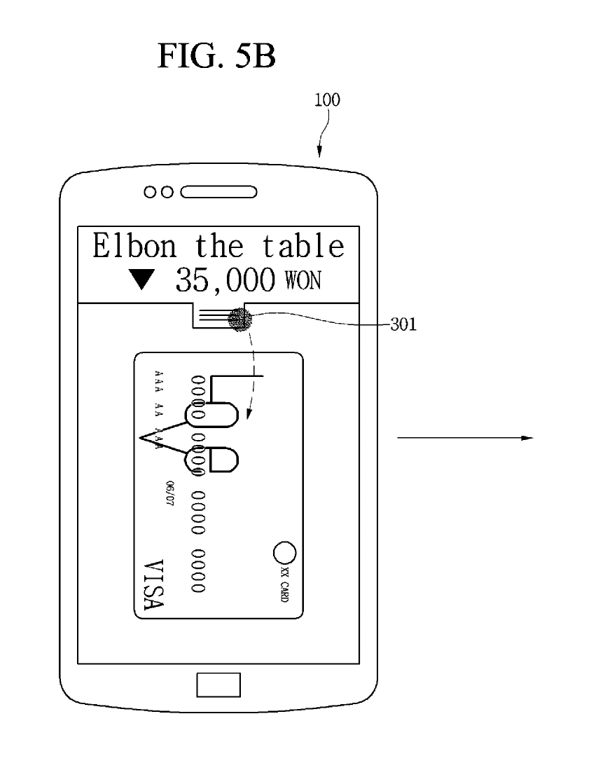

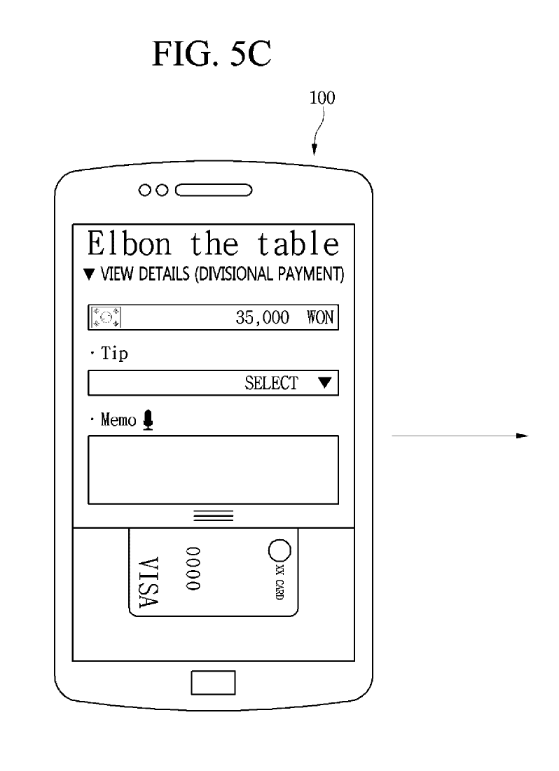

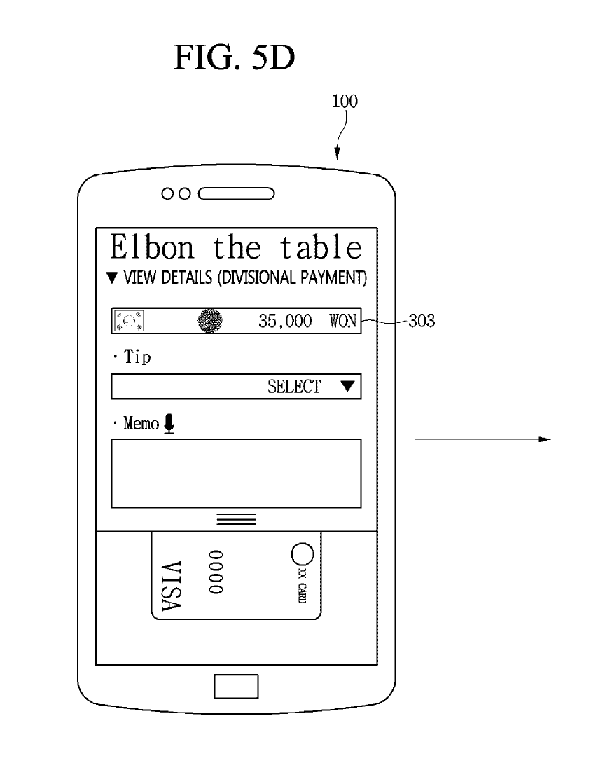

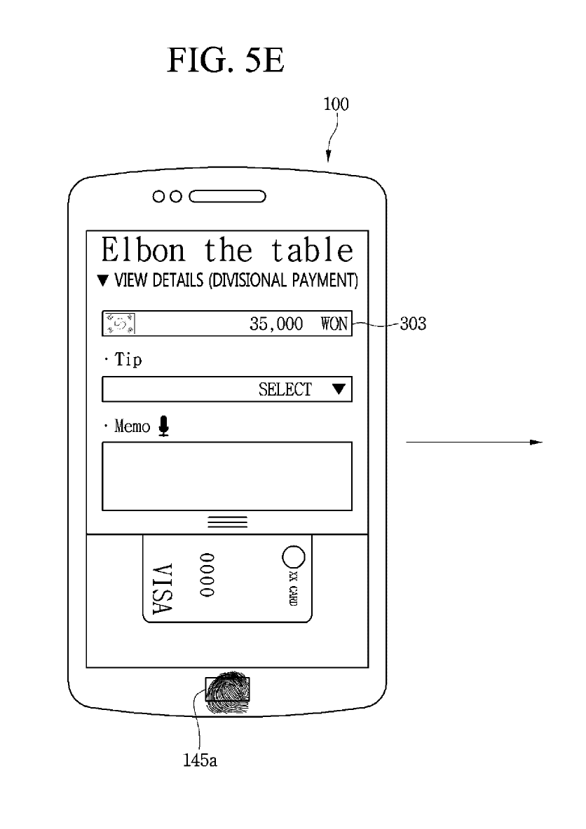

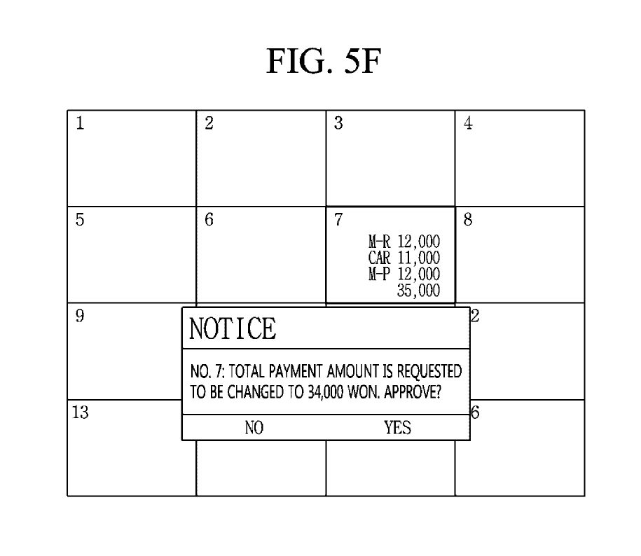

Hereinafter, a method of providing a variety of selection information related to payment will be described with reference to FIGS. 5 to 21. Although the finger scan sensor 145a installed in the front surface of the mobile terminal 100 is used in the following description, the finger scan sensor 145b installed in the rear surface of the mobile terminal 100 may be used.

FIG. 5 is a diagram showing screens explaining a method of modifying a payment amount. As shown in FIG. 5a, when an order is-finished by a user, the payment terminal 200 generates and prepares to transmit the payment information and the selection information related to payment to the mobile terminal 100 according to the finished order.

At this time, the mobile terminal 100 and the payment terminal 200 are activated to transmit and receive data to and from each other through short-range wireless communication. That is, the short-range communication module 114 of the mobile terminal 100 and the short-range communication module 114 of the payment terminal 200 are activated to transmit and receive data between the short-range communication module 114 of the mobile terminal 100 and the short-range communication module 114 of the payment terminal 200 anytime.

When card information is displayed on the display unit 151 of the mobile terminal 100 for payment, the controller 180 of the mobile terminal 100 may recognize that the card information is displayed on the display unit 151 and transmit the recognized information to the payment terminal 200, and the payment terminal 200 may transmit the payment information and the selection information related to payment to the mobile terminal 100 in response to the recognized information received from the mobile terminal 100. Here, the card information may be a card image including a card name, a card number, an expiration date, etc., without being limited thereto.

For example, a card icon displayed on the display unit 151 of the mobile terminal 100 may be executed to display the card information on the display unit 151. For example, the card icon may be provided in a status bar located at an upper end of the display unit 151 of the mobile terminal 100 and may be executed to display the card information on the display unit 151.

As shown in FIG. 5b, the payment information and the selection information related to payment received from the payment terminal 200 may be hidden in a payment queue 301. When the user inputs a gesture of dragging the payment queue 301 in one direction, for example, from top to bottom, as shown in FIG. 5c, the controller 180 may move the payment queue 301 downward and display the payment information and the selection information related to payment on the display unit 151.

As shown in FIG. 5d, when the user inputs a gesture of touching a payment amount window 303, the payment amount window 303 may be activated to modify a payment amount. For example, when the gesture of touching the payment amount window 303 is received, the controller 180 may display a drum wheel object including amounts less or greater than the payment amount displayed in the payment amount window 303 on the display unit 151.

For example, when 35,000 won is displayed in the payment amount window 303, 34,500 won and 34,000 won may be displayed above 35,000 won and 35,500 won and 36,000 won may be displayed below 35,000 won. In this case, the amounts may be moved by input of the gesture of dragging upward or downward by the user and a specific amount may be re-set as a payment amount by input of touching the specific amount.

For example, when the gesture of touching the payment amount window 303 is input, a key input window may be displayed and, when a desired amount is input by the user through a selection command for the key input window, the payment amount displayed in the payment amount window 303 may be adjusted to the amount input by the user. When the user thinks that the payment amount is large, the user may modify the payment amount to a desired amount thereof.

As shown in FIG. 5e, when the user inputs the fingerprint of the user through the finger scan sensor 145a, the controller 180 may perform fingerprint authentication based on the input fingerprint and transmit the modified payment amount information to the payment terminal 200 when fingerprint authentication succeeds. As described below, in the present invention, a fingerprint and a signature are pre-set to be linked to each other. Therefore, when only the fingerprint is input such that fingerprint authentication succeeds, since a process of signing a signature for payment is not performed, it is possible to easily make payment.

As shown in FIG. 5f, the payment terminal 200 may display a message indicating that the user has modified the payment amount on the screen based on the modified payment amount information received from the mobile terminal 100. If a clerk of the payment terminal 200 approves the modified payment amount, payment may be made and finished with the modified payment amount.

If a clerk of the payment terminal 200 does not approve the modified payment amount, the payment terminal 200 may transmit a message indicating that approval is rejected to the mobile terminal 100. Based on rejection of approval, the user of the mobile terminal 100 may modify the payment amount to the original payment amount to make payment or modify the modified payment amount again to request payment. In the present invention, the user and the clerk may adjust the payment amount using the mobile terminal 100 and the payment terminal 200 to finish payment with an appropriate amount.

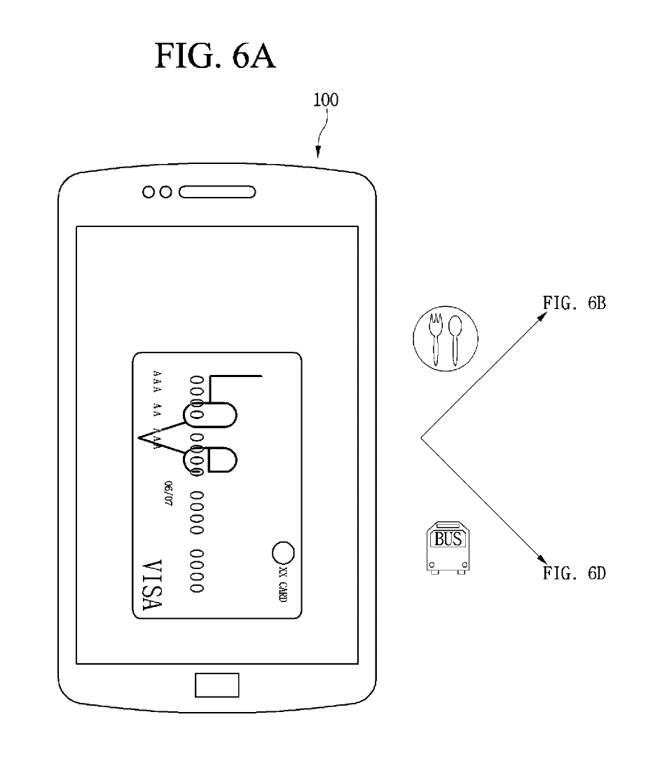

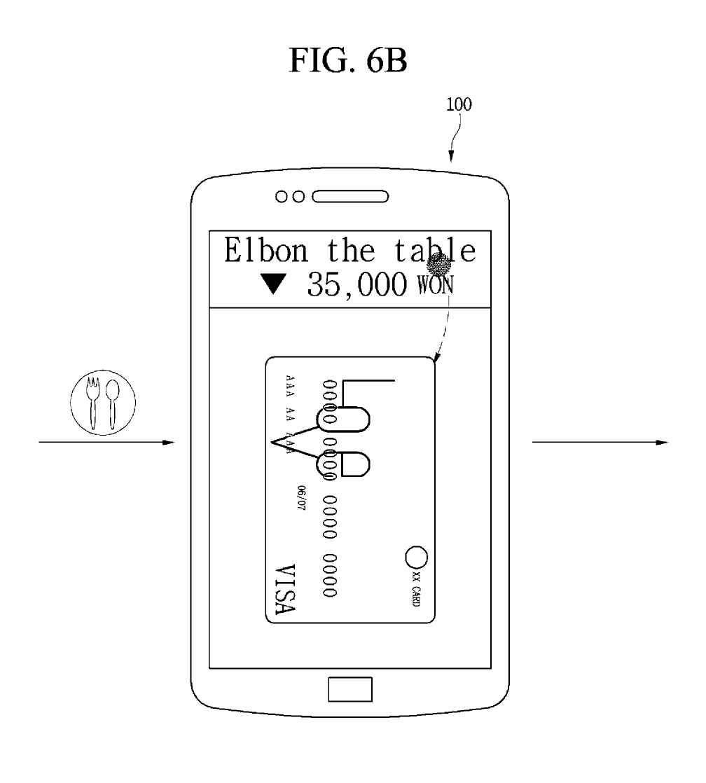

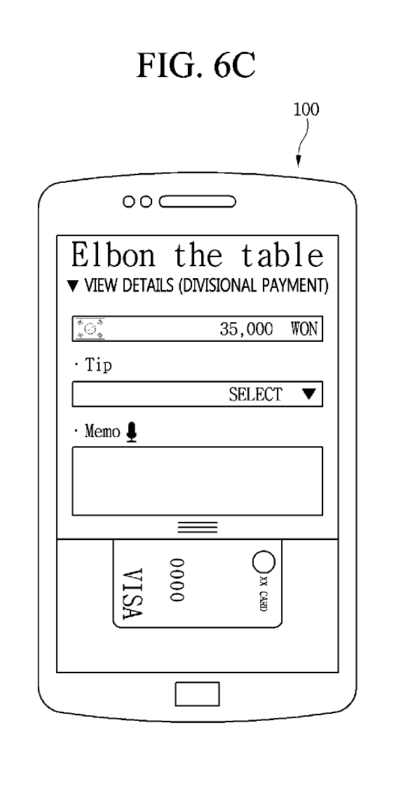

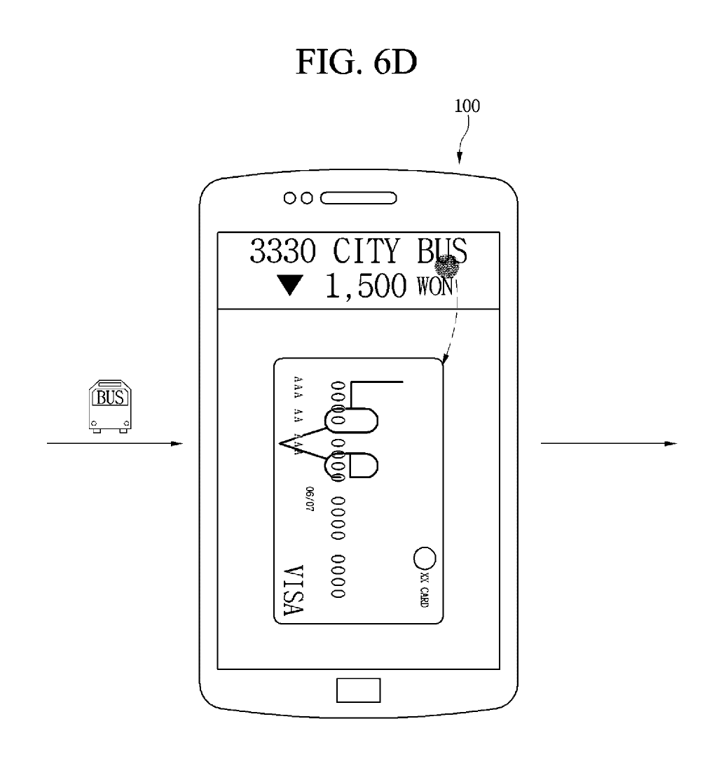

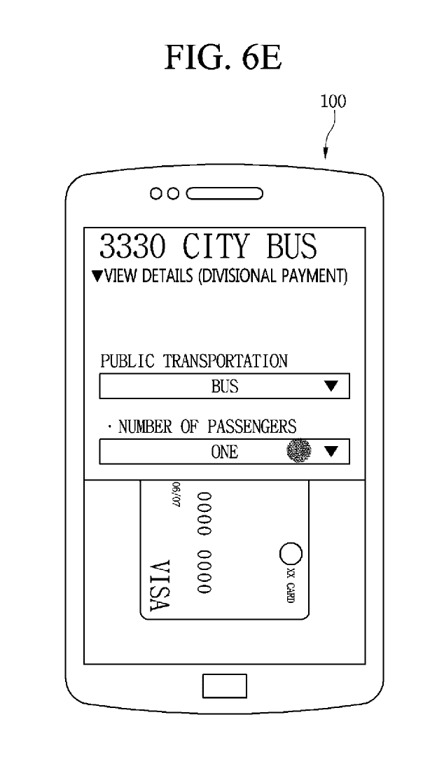

FIG. 6 is a diagram showing a state of providing different payment related selection information according to a place where a payment terminal is located. As shown in FIG. 6a, when the card information is displayed on the display unit 151 of the mobile terminal 100, the payment information and the selection information related to payment may be transmitted from the payment terminal 200 to the mobile terminal 100. At this time, the selection information related to payment may be changed according to a place where the mobile terminal 100 is located. For payment, the selection information may be changed according to a place where the payment terminal 200 connected to the mobile terminal 100 is located.

As shown in FIGS. 6b and 6c, when the mobile terminal 100 is located at a restaurant, the selection information transmitted from the payment terminal 200 of the restaurant to the mobile terminal 100 may include tip addition, memo input and parking related input, as described above. In contrast, as shown in FIGS. 6d and 6e, when the mobile terminal 100 is located in a bus, the selection information from the payment terminal 200 mounted in the bus to the mobile terminal 100 may include a bus type such as a broad-area bus or an express bus, the number of passengers, and the age of each passenger. The payment terminal 200 installed in the bus is used to pay a bus fare. Selection information specialized for the bus fare may be generated by the payment terminal 200 and provided to the mobile terminal 100.

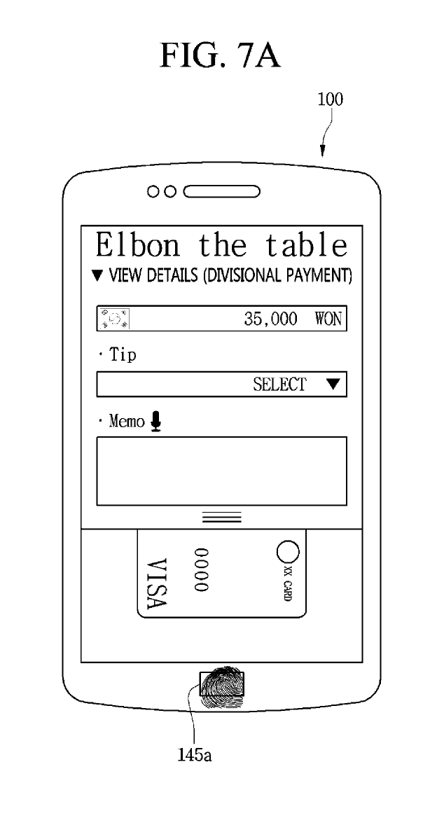

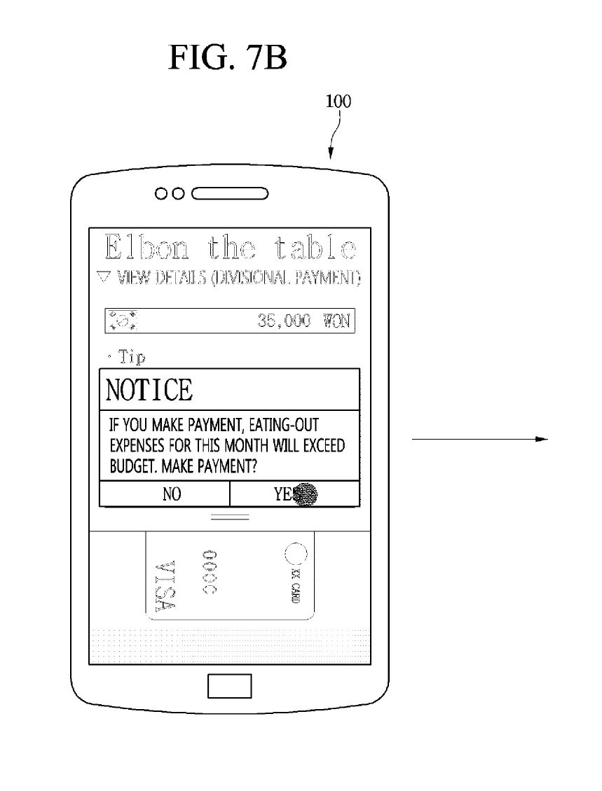

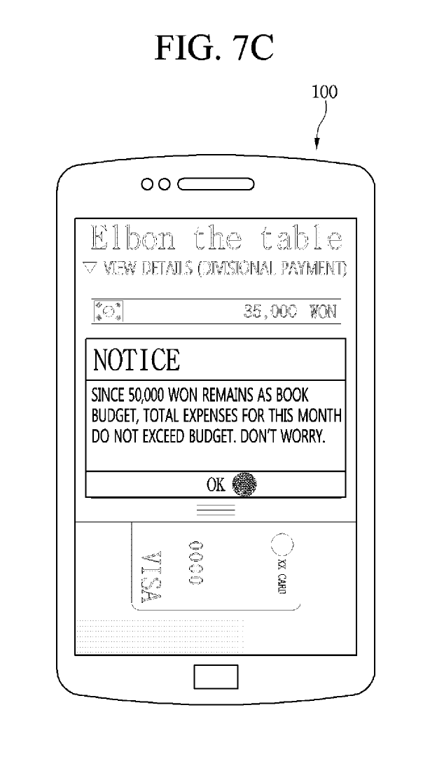

FIG. 7 is a diagram showing screens showing a help provision function coupled with a household budget. As shown in FIG. 7a, when a user inputs the fingerprint of the user through the finger scan sensor 145a for payment, the controller 180 may perform fingerprint authentication based on the input fingerprint and transmit a payment approval request to the payment terminal 200 to make payment through the payment terminal 200 when fingerprint authentication succeeds.

However, as shown in FIG. 7b, a household-ledger application including a plurality of items and a payment service are linked. When fingerprint authentication for payment succeeds, the controller 180 may execute the household-ledger application to determine whether eating-out expenses for this month exceed a budget upon making payment and display the determined result on the display unit 151. The plurality of items may include transportation expenses, communication expenses, education expenses, and travel expenses.

Upon determining that the eating-out expenses for this month exceed the budget when the payment amount is paid, the controller 180 may display a message indicating that the eating-out expenses for this month exceed the budget on the display unit 151 to give the user a choice. Although the eating-out expenses for this month exceed the budget, when the user makes a request for approving payment on the message, the controller 180 may transmit a payment approval request to the payment terminal 200 to make payment.

Meanwhile, as shown in FIG. 7c, when expense is diverted to another budget, e.g., a book budget through execution of the household-ledger application, the controller 180 may display a message indicating that the eating-out expenses exceed the budget but may be diverted to another budget on the display unit 151 to give the user a choice. In the present invention, payment may be linked to the household budget, thereby managing the household budget through payment.

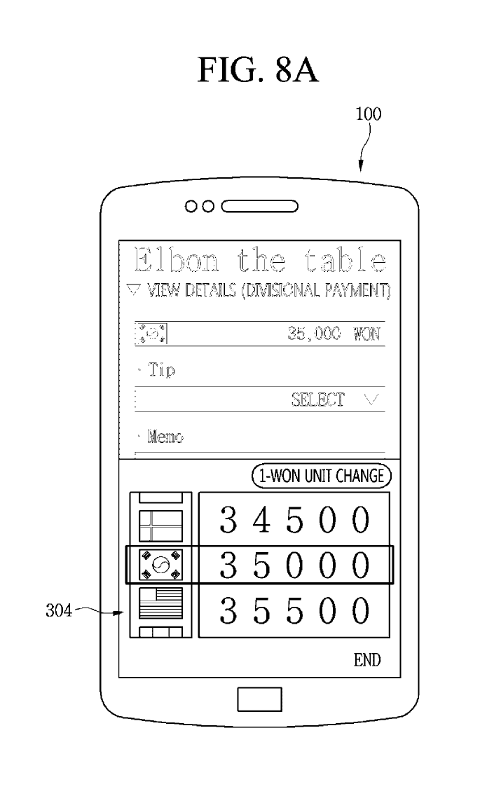

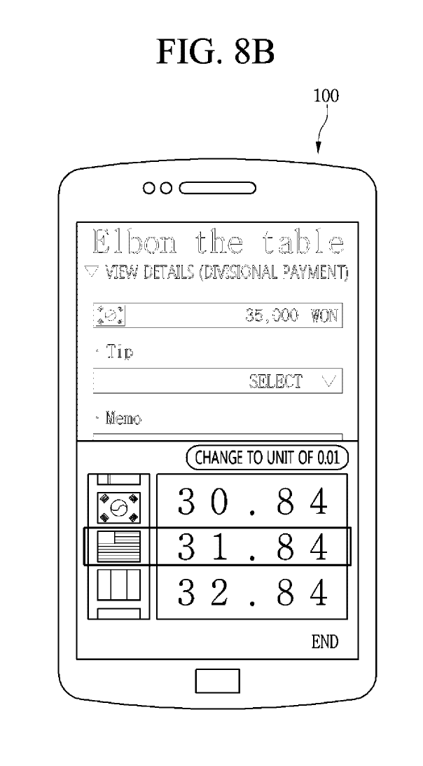

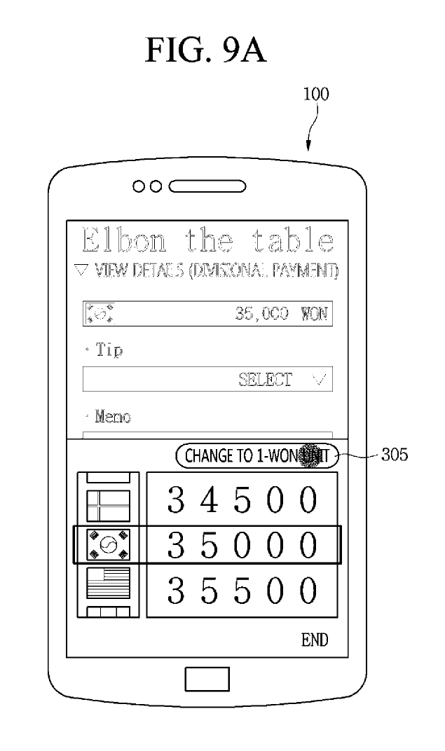

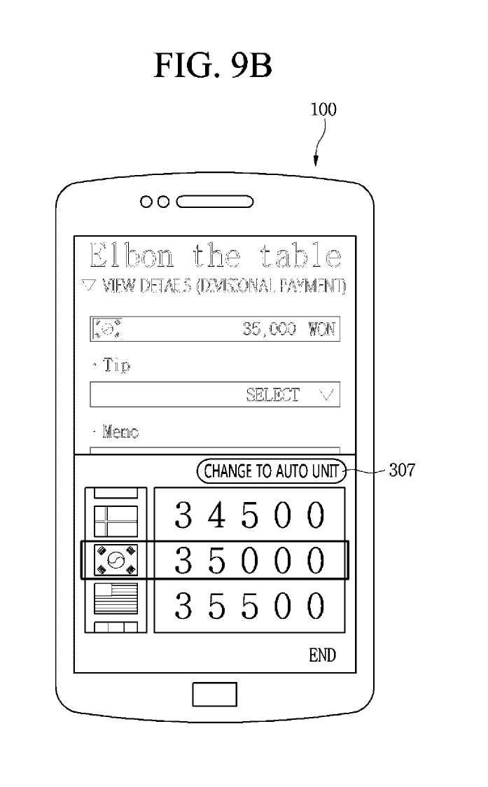

FIGS. 8 and 9 are diagrams showing screens showing a state of changing currency and a unit of amount of money. When the gesture of dragging the payment queue 301 is input as shown in FIG. 5b, as shown in FIG. 8a, the controller 180 may display a drum wheel object 304 including a country currency name and an amount of money modifiable from a payment amount on the display unit 151.

Alternatively, when the gesture of touching a country currency button (not shown) provided on the screen, on which the payment information and the selection information related to payment is displayed, is input as shown in FIG. 5c, the drum wheel object 304 shown in FIG. 8a may be displayed. For example, when Korean currency is selected through a drag gesture and a touch gesture, amounts of money corresponding to Korean currency may be displayed. As shown in FIG. 8a, when Korean currency is selected, the payment amount is set to 35,000 won as a criterion, 34,500 won and 34,000 won are displayed above 35,000 won and 35,500 won and 36,000 won are displayed below 35,000 won.

When another currency, for example, American currency is selected through the drag gesture and the touch gesture, as shown in FIG. 8b, amounts of money corresponding to American currency may be displayed. When American currency is selected, the payment amount is set to $31.84 as a criterion, $30.84 and $29.84 are displayed above $31.84 and $32.84 and $33.84 are displayed below $31.84.

Meanwhile, when Korean currency is selected and 35,000 won is set as the criterion, the criterion may be adjusted to another amount of money. For example, as shown in FIG. 8a, the criterion set to 35,000 won may be changed to 34,500 or 36,000 won through the drag gesture and the touch gesture.

In contrast, although, in the case of Korean currency, the payment amount may be divided in units of 500 won in FIG. 8a, the payment amount may be divided in units of 1 won, 10 won, 50 won or 100 won. For example, when a gesture of touching a 1-won unit change button 305 displayed on the display unit 151 is input as shown in FIG. 9a, as shown in FIG. 9b, amounts of money divided in units of 1 won may be displayed based on 35,000 won.

At this time, the 1-won unit button may be changed to an auto unit button 307. Through the auto unit button 307, amounts of money may be displayed in units of at least one of 1 won, 10 won, 50 won or 100 won. Although not shown in FIG. 9a, a 10-won unit button, a 50-won unit button and a 100-won unit button may be displayed on the display unit 151.

Alternatively, the 1-won unit button may be changed to the 10-won unit button when the 1-won unit button is touched once, and the 10-won unit button may be changed to the 50-won unit button when the 10-won unit button is touched once. In addition, the 50-won unit button may be changed to the 100-won unit button when the 50-won unit button is touched once, and the 100-won unit button may be changed to the auto unit button when the 100-won unit button is touched once

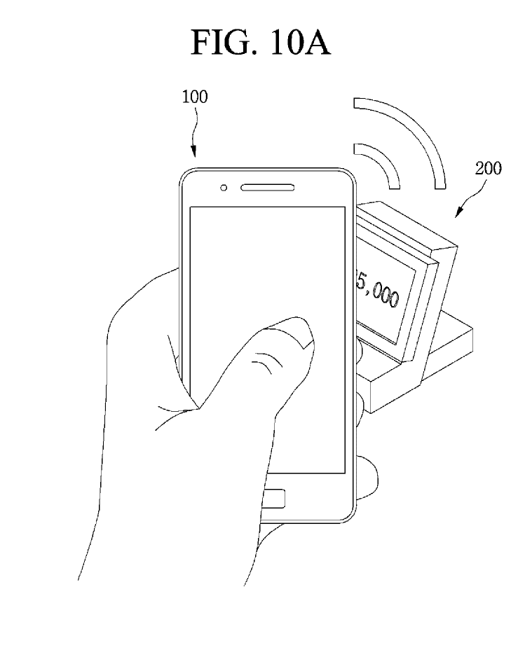

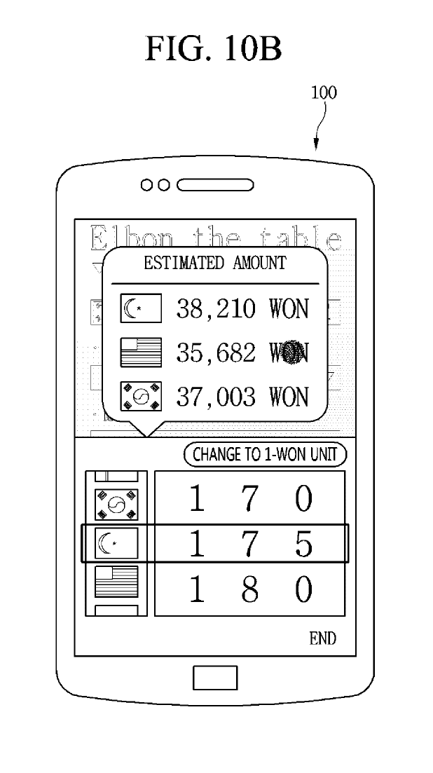

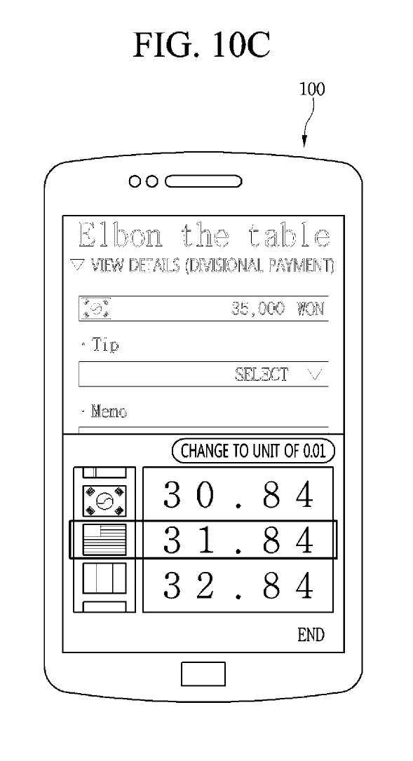

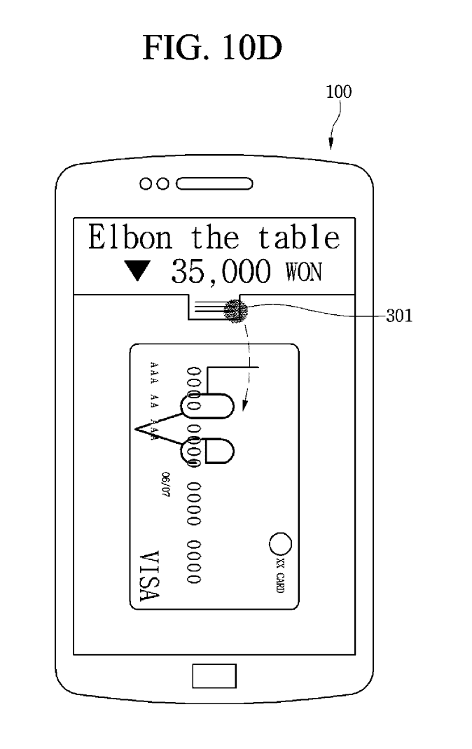

FIG. 10 is a diagram showing screens explaining a method of reading a current exchange rate and recommending currency to a user. As shown in FIG. 10a, when card information is displayed on the mobile terminal 100 for payment, the controller 180 may inform the payment terminal 200 of display of the card, receive the payment information and the selection information related to payment from the payment terminal 200, and store the received payment information and selection information related to payment in the memory.

As shown in FIG. 10d, when a gesture of dragging the payment queue 301 is input, the controller 180 may display the payment information and the selection information related to payment on the display unit 151. Before the payment information and the selection information related to payment is displayed, as shown in FIG. 10b, the controller 180 may display an estimated amount when currency of each country is changed to Korean currency (Korean won).

Accordingly, in the present invention, the user may easily check which currency should be used in order to make payment at a lowest price through the estimated amount. For example, when the user places an order at a German restaurant in Euro, a payment amount for the order is preferentially provided in Euro and an estimated amount when Euro is changed to Korean currency may be displayed.

When the payment amount is 175 euros, the estimated amount upon making payment with Korean currency is 37,003 won and the estimated amount upon making payment with American currency (US dollar) is 35,682 won, and the estimated amount upon making payment in Euro is 38,210 won. Accordingly, the user may easily check that the estimated amount is lowest upon making payment with American currency.

When the user inputs a gesture of touching the estimated amount upon making payment with American currency, as shown in FIG. 10c, the payment amount may be changed from 175 euros to $31.84. Since $31.84 may be paid, the present invention may enable the user to select the cheapest currency, thereby improving user convenience.

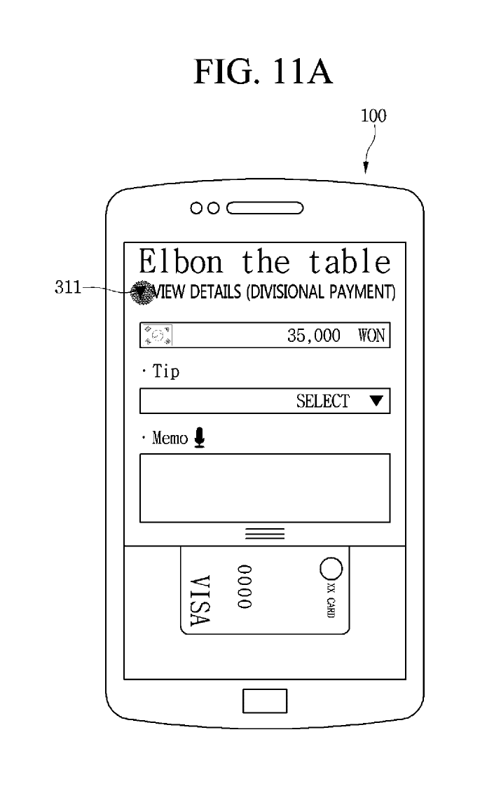

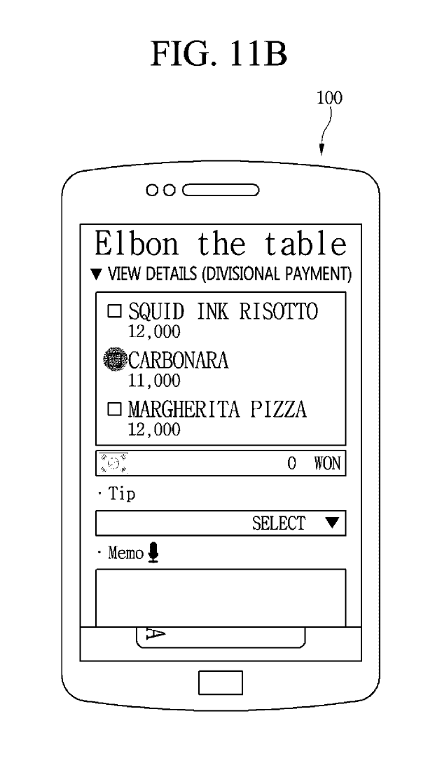

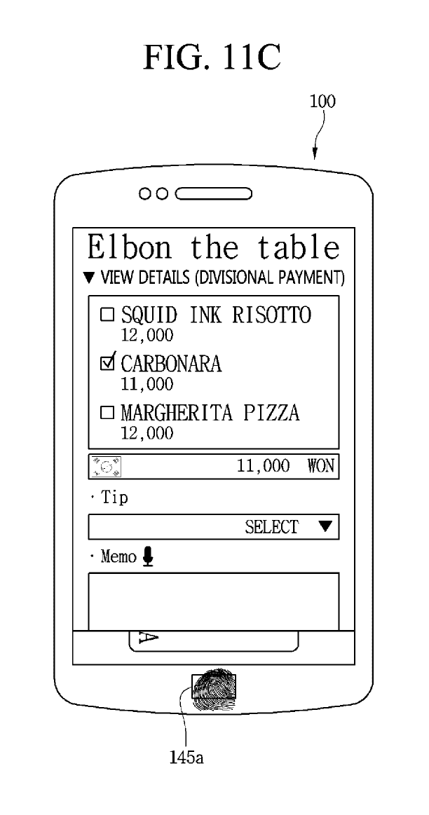

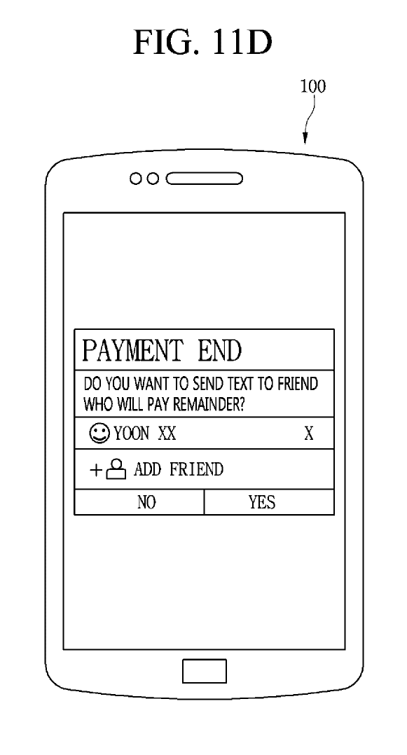

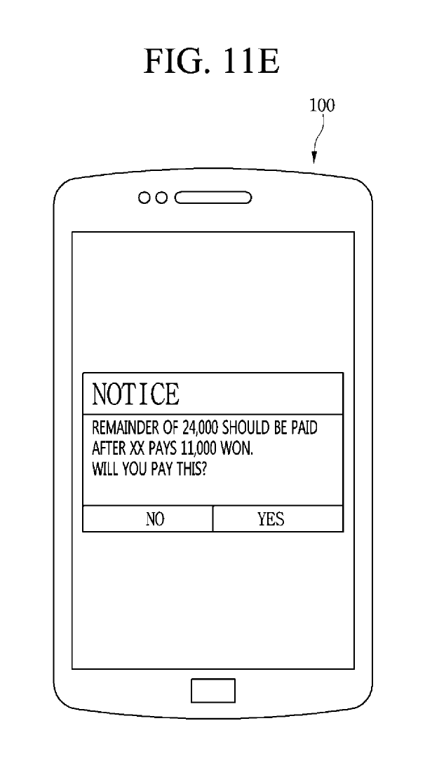

FIG. 11 is a diagram explaining a partial payment method of paying some of a total payment amount. As shown in FIG. 11a, payment information and selection information may be displayed on the display unit. When the user inputs a gesture of touching a details-viewing button for partial payment, as shown in FIG. 11b, the controller 180 may display details including ordered items on the display unit 151.

The ordered items may include Squid Ink Risotto, Carbonara, Margherita Pizza, etc., for example. When the user pays for one of three items and inputs a gesture of touching Carbonara, as shown in FIG. 11c, the controller 180 performs control to select Carbonara. Thereafter, when the user inputs a fingerprint thereof through the finger scan sensor 145a, the controller 180 may perform fingerprint authentication based on the input fingerprint and transmit a payment approval request to the payment terminal 200 when fingerprint authentication succeeds, such that payment is made and finished by the payment terminal 200.

When payment is finished, the controller 180 may display a message indicating whether payment for the items, for which payment is not made, e.g., Squid Ink Risotto and Margherita Pizza, is transmitted to a friend on the display unit 151. Here, the friend may be a tablemate and the number of friends may be one or more.

A person who will pay the remainder may be added through a friend addition function. For example, when the user takes a picture with a tablemate, the tablemate may be identified through the picture. If information on the identified tablemate is stored in the mobile terminal 100, the personal information of the tablemate may be displayed on the message through the friend addition function.

As another example, if the tablemate is written in a calendar along with a date and time and a place, the calendar may be activated at the date and time, memory is searched for personal information of the tablemate, and the personal information of the tablemate may be displayed on the message through the friend addition function when the personal information of the tablemate is present in the memory.

In contrast, the user may directly search for the personal information of the tablemate and add the tablemate as the person who is requested to pay the remainder using the friend addition function. When a gesture of touching an acceptance button is input with respect to the person who is requested to pay the remainder, included in the message shown in FIG. 11d, as shown in FIG. 11e, the controller 180 may transmit a message for requesting payment of the remainder on the screen of the mobile terminal 100 of the person.

Although the message shown in FIG. 11e shows that a specific person pays the remainder, the information may be displayed on the mobile terminal 100 of the specific person such that the specific person may select and pay for any one item as shown in FIG. 11b. To this end, the controller 180 of the mobile terminal 100 of the user may transmit information on a list including Squid Ink Risotto and Margherita Pizza except for the Carbonara paid by the user to the mobile terminal 100 of the person who will pay the remainder, as shown in FIG. 11b. The information on the list may be displayed on the mobile terminal 100 of the person and the person may select and pay one or both of Squid Ink Risotto and Margherita Pizza included in the list.

In summary, the following scenario is possible. Assume that Participant A, Participant B and Participant C have visited a restaurant and Participant A has ordered Squid Ink Risotto, Participant B has ordered Carbonara and Participant C has ordered Margherita Pizza.

As a first scenario, after payment for Squid Ink Risotto is made using a first mobile terminal of Participant A, a message indicating a request for payment for Carbonara is transmitted to a second mobile terminal of Participant B and a message indicating a request for payment for Margherita Pizza is transmitted to a third mobile terminal of Participant C, by the first mobile terminal. In this case, payment for Carbonara is made using the second mobile terminal and payment for Margherita Pizza may be made using the third mobile terminal.

As a second scenario, after payment for Squid Ink Risotto is made using a first mobile terminal of Participant A, a message indicating information on a list including Carbonara and Margherita Pizza is transmitted to a second mobile terminal of Participant B by the first mobile terminal. After payment for Carbonara is made using the second mobile terminal, a message indicating a request for payment for Margherita Pizza is transmitted to a third mobile terminal of Participant C. Thereafter, payment for Margherita Pizza may be made using the third mobile terminal.

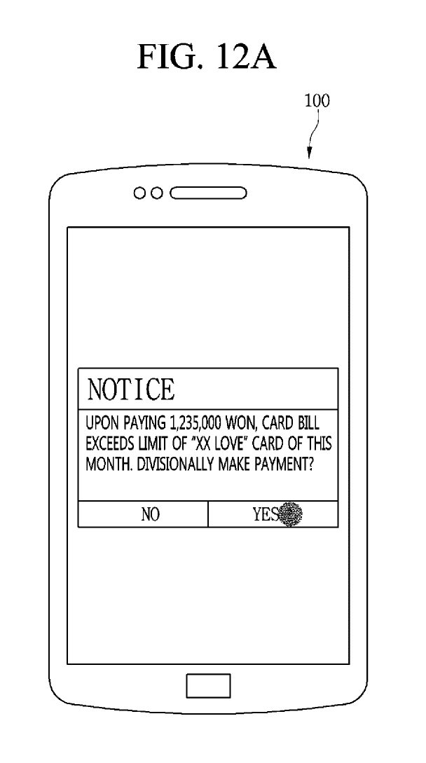

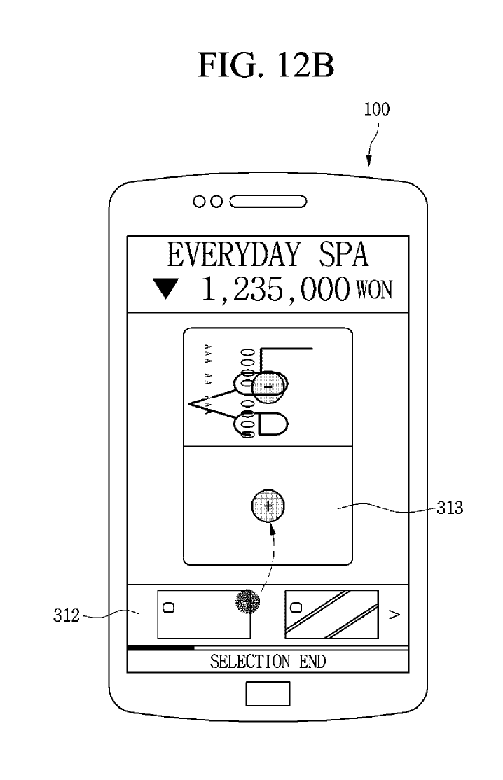

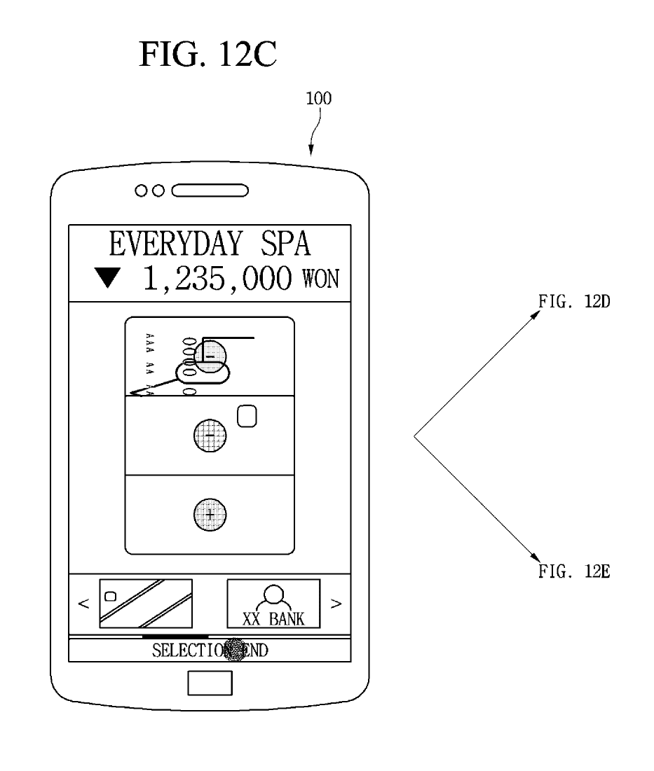

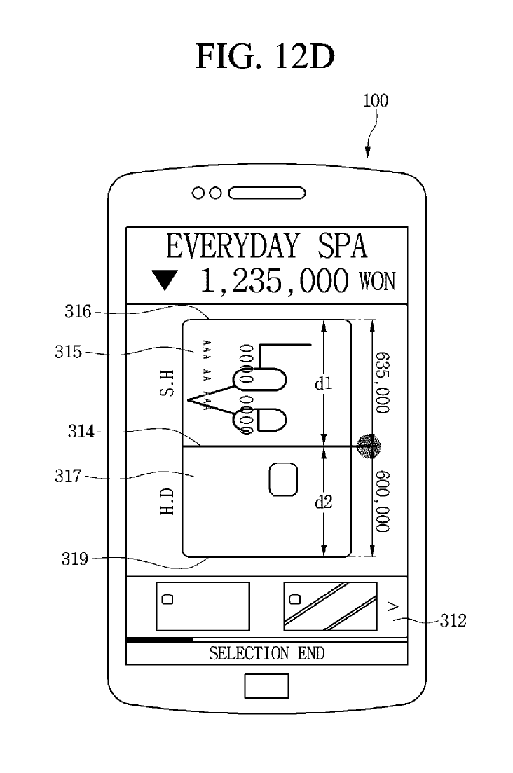

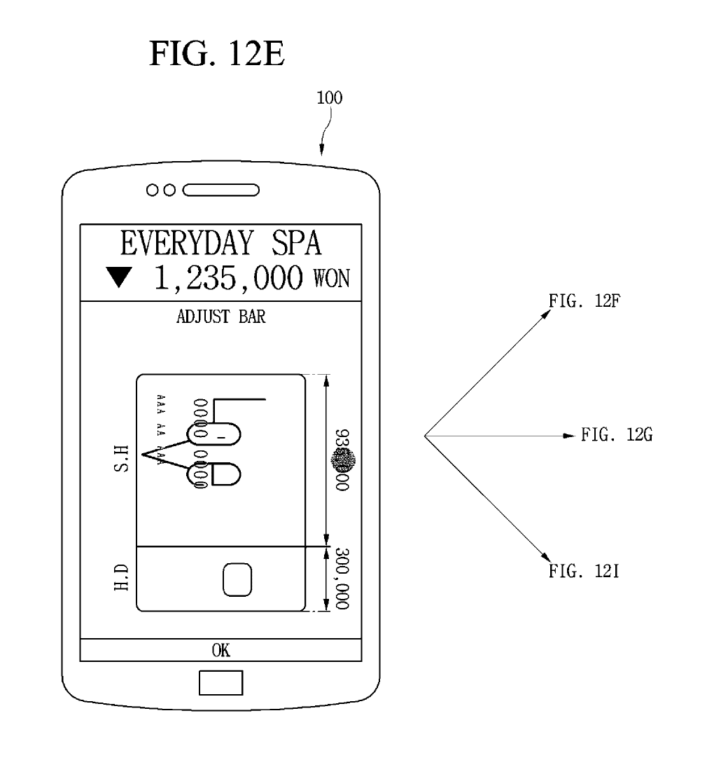

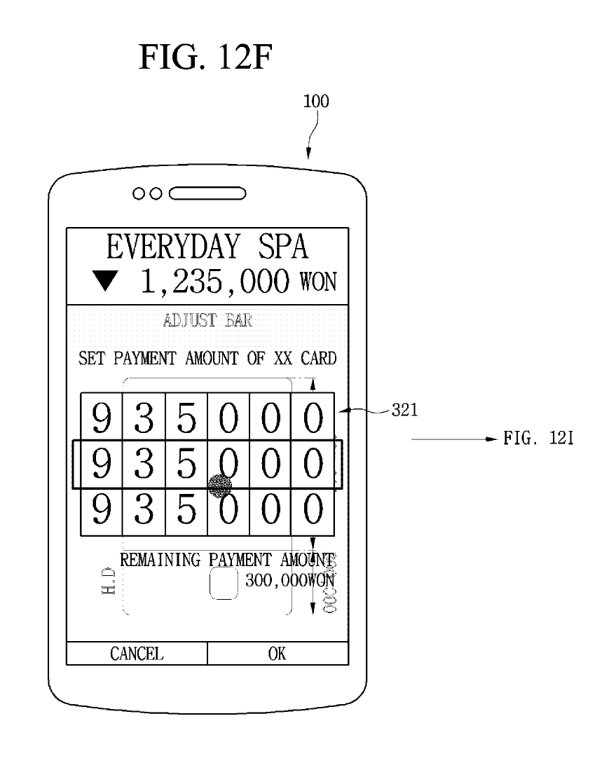

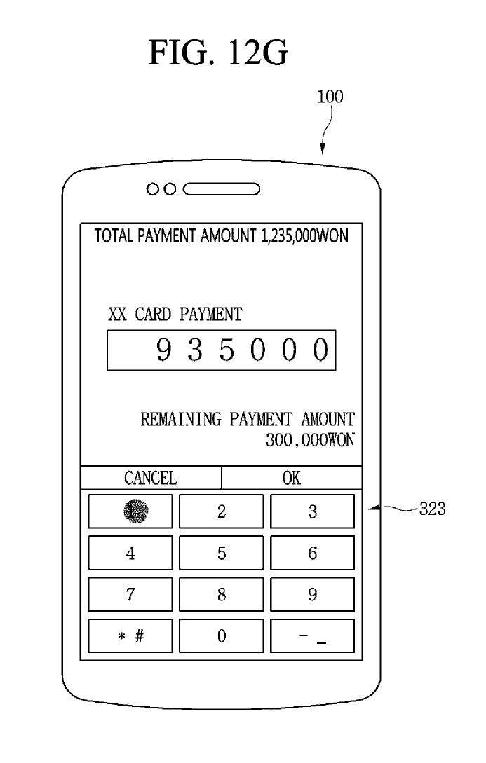

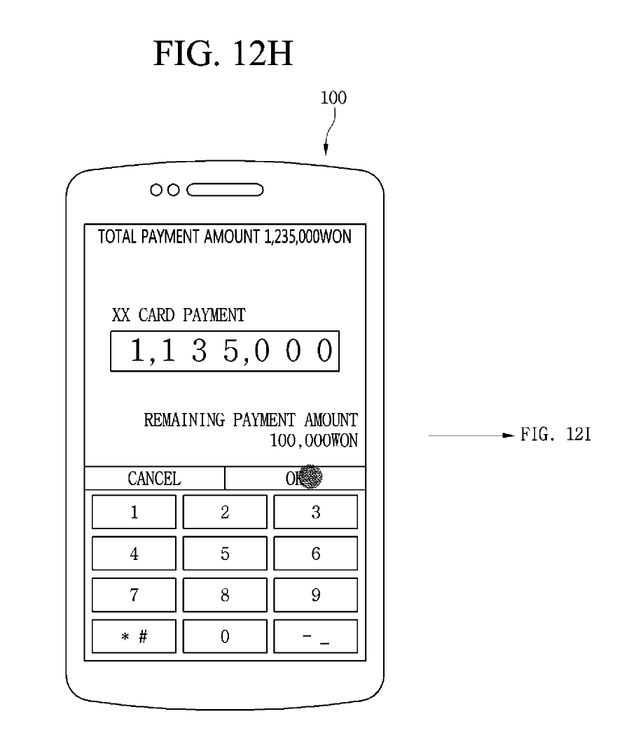

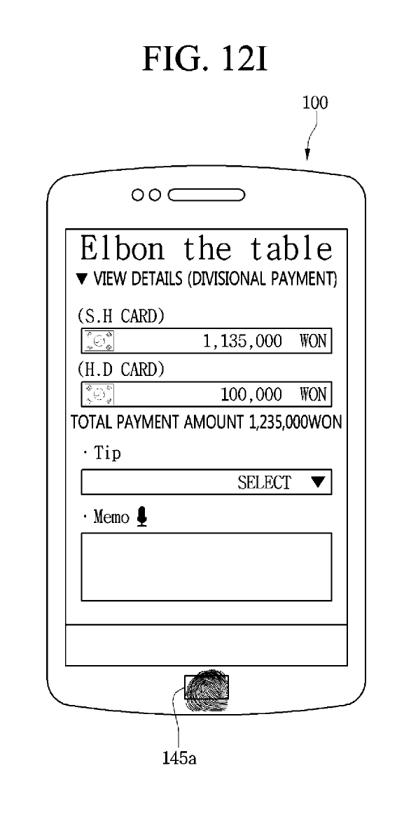

FIG. 12 is a diagram showing screens explaining a method of divisionally making payment using at least one card. As shown in FIG. 12a, when payment of a payment amount included in payment information received from the payment terminal 200 or a modified payment amount thereof is requested and a card bill exceeds a limit, the controller 180 may display a message indicating whether payment is divisionally made using the card currently ready for making payment and another card on the display unit 151.

Upon determining that payment is divisionally made using the card currently ready for making payment and another card, as shown in FIG. 12b, the controller 180 may display a list window 312 and an additional window 313 on the display unit 151. In the list window 312, one or more pieces of card information, which is registered with the mobile terminal 100 and may be added to the additional window 313, may be displayed.

In the additional window 313, card information selected from among card information displayed in the list window 312 may be added and card information to be used for divisional payment along with the card information currently ready for payment may be added. For example, when a gesture of touching and dragging specific card information among at least one piece of card information displayed in the list window 312 is input, the specific card information may be moved in the direction of the drag gesture and displayed in the additional window 313 when a gesture of releasing touch is input at a specific position, for example, on the additional window 313.

In contrast, when a gesture of touching and dragging the specific card information displayed in the additional window 313 is input, the specific card information may be moved in the direction of the drag gesture and displayed in the list window 312 when a gesture of releasing touch is input at a specific position, for example, on the list window 312. Therefore, the user may move desired card information from the list window 312 to the additional window or from the additional window 313 to the list window 312.

As shown in FIG. 12c, when specific card information is displayed in the additional window 313, an additional window 312 to which new card information may be added may be newly generated and displayed. Other card information selected in the list window 312 may be moved to and displayed in the newly generated additional window 313.

When desired card information is moved to the additional window 313 and the user inputs a gesture of touching a selection complete button, the controller 180 displays the card information (first card information) 315 ready for payment and newly added card information (second card information) 317 and displays a payment amount allocated to the cards near the card information 315 and 318, for example, at the right sides of the card information.

As shown in FIG. 12d, the controller 180 may display a first reference line 316 above the first card information 315, a second reference line 319 below the second card information 317, and a payment amount adjustment bar 314 at the boundary between the first card information 315 and the second card information 317. The first reference line 316 and the second reference line 319 are fixed, but the payment amount adjustment bar 314 may be moved upward/downward.

Assume that an interval between the first reference line 316 and the payment amount adjustment bar 314 is d1 and an interval between the payment amount adjustment bar and the second reference line 319 is d2. In this case, the first card information 315 may be displayed in the interval d1 between the first reference line 316 and the payment amount adjustment bar and the second card information 317 may be displayed in the interval d2 between the payment amount adjustment bar and the second reference line 319.

The interval d1 between the first reference line 316 and the payment amount adjustment bar and the interval d2 between the payment amount adjustment bar and the second reference line 319 are changed by movement of the payment amount adjustment bar, the payment amount of the first card and the payment amount of the second card may be adjusted in correspondence with change in interval. At this time, the adjusted payment amount of the first card and the adjusted payment amount of the second card may be displayed.

For example, when the user inputs a gesture of touching and dragging the payment amount adjustment bar, the controller 180 may move the payment amount adjustment bar in the drag direction. As the intervals d1 and d2 are increased, the payment amounts may be increased. For example, if the drag direction is upward, the payment amount adjustment bar is moved upward and the interval d1 between the first reference line 316 and the payment amount adjustment bar is decreased to decrease the payment amount of the first card. However, the interval d2 between the payment amount adjustment bar and the second reference line 319 is increased to increase the payment amount of the second card.

In contrast, if the drag direction is downward, the payment amount adjustment bar is moved downward and the interval d1 between the first reference line 316 and the payment amount adjustment bar is increased to increase the payment amount of the first card. However, the interval d2 between the payment amount adjustment bar and the second reference line 319 is decreased to decrease the payment amount of the second card.

As shown in FIGS. 12e to 12h, the payment amount of each card may be directly input. That is, as shown in FIG. 12e, for example, when a gesture of touching the payment amount (935,000 won) displayed at the right side of the first card information 315 is input, the controller 180 may display the drum wheel object 321 capable of adjusting the payment amount as shown in FIG. 12f. The payment amount may be adjusted using the drum wheel object 321.

As another example, when a gesture of touching the payment amount (935,000 won) displayed at the right side of the first card information 315 is input, the controller 180 may display a numeric key 323 as shown in FIG. 12g. The payment amount of the card may be adjusted through a selection command for the numeric key 323.

When the payment amount for each card is adjusted, as shown in FIG. 12i, the controller 180 may display the adjusted payment amount of each card, perform fingerprint authentication when the user checks the adjusted payment amount and inputs the fingerprint thereof through the finger scan sensor 145a, and transmit a payment approval request to the payment terminal 200 when fingerprint authentication succeeds. Therefore, the payment terminal 200 may pay the payment amounts divisionally allocated to the cards.

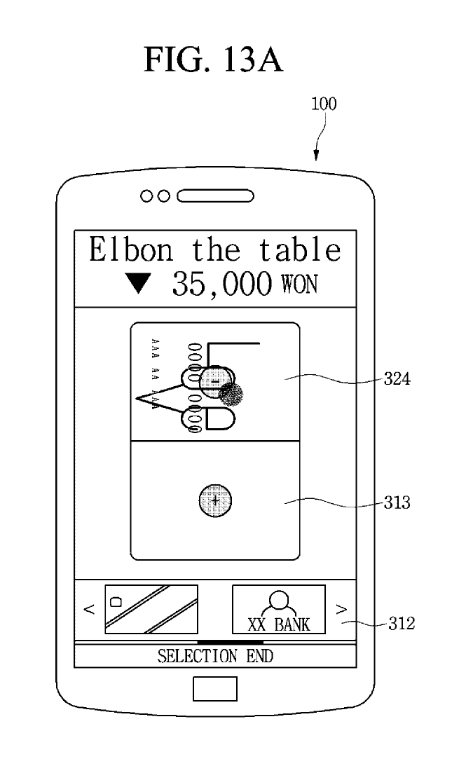

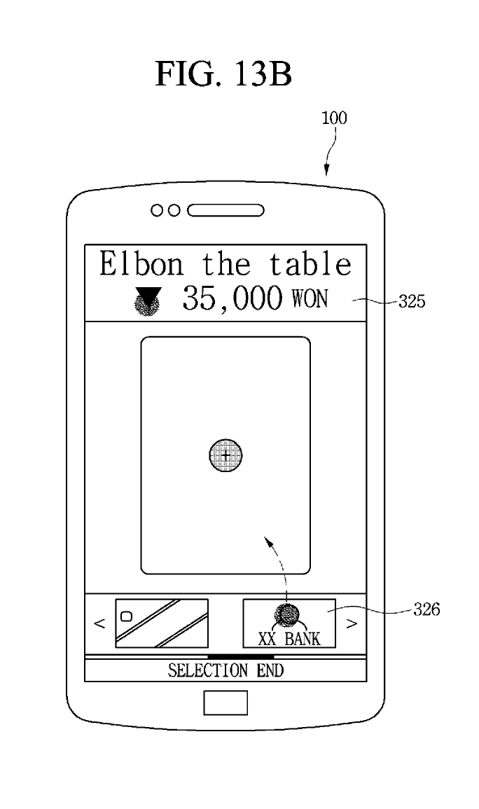

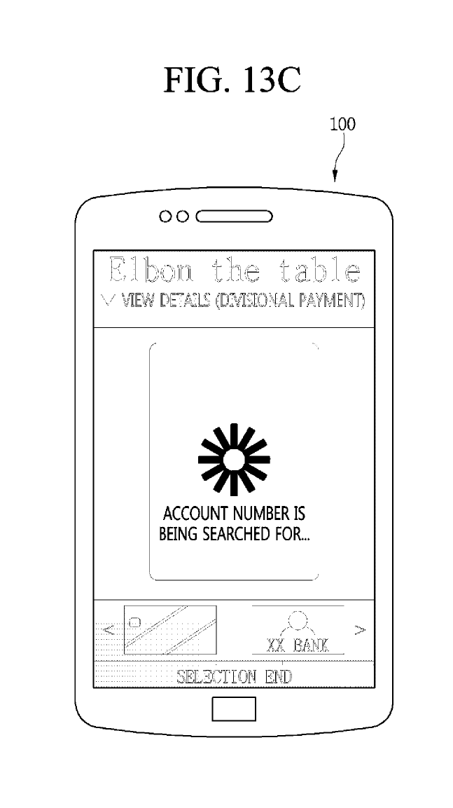

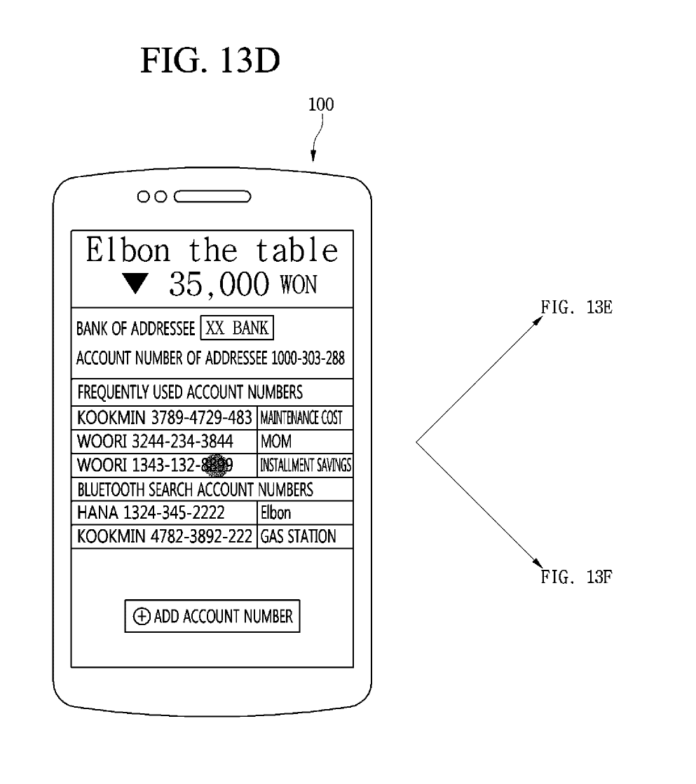

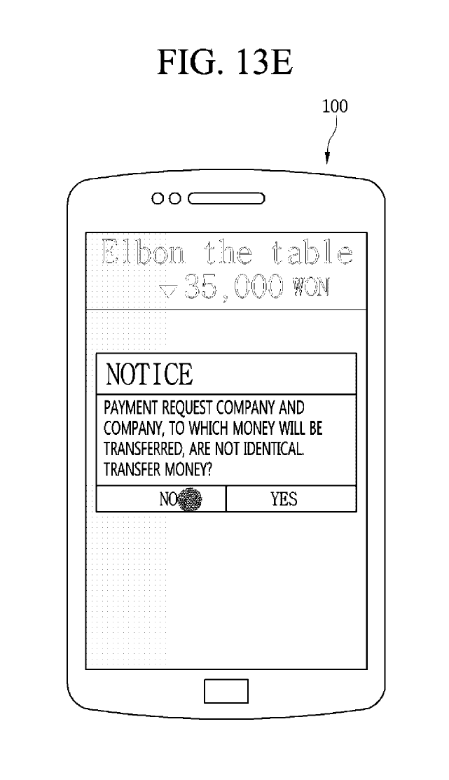

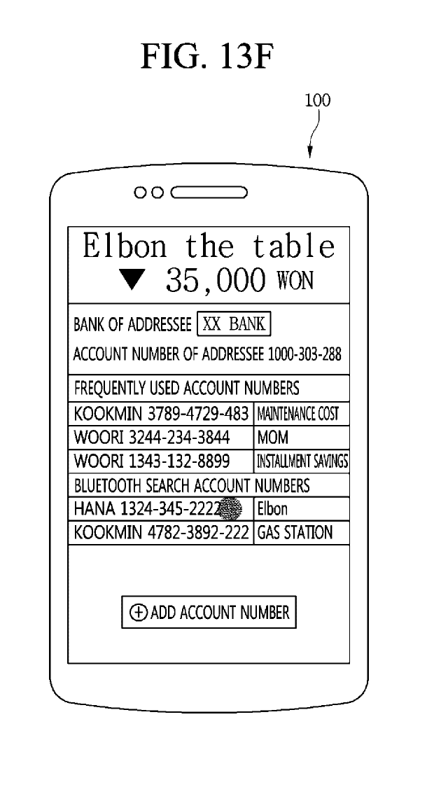

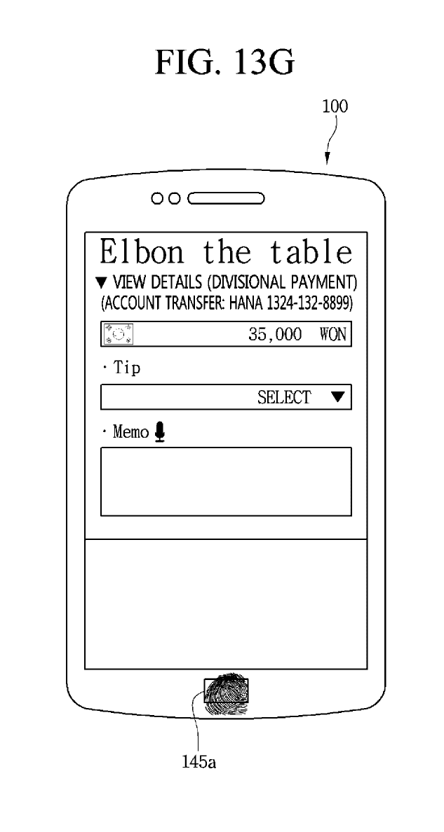

FIG. 13 is a diagram showing screens explaining a state of making payment through account transfer. As shown in FIG. 13a, the controller 180 may display a list window 312 and an additional window 313 on the display unit 151. In the list window 312, at least one piece of card information or bank information registered with the mobile terminal 100 and addible to the additional window 313 may be displayed.

The card information or bank information displayed in the list window 312 may be added to the additional window 313. If the user desires to make payment using a bank account instead of the card currently ready for payment displayed on the display unit 151, the card information 324 currently ready for payment is removed and the card displayed in the list window 312 is added to the additional window 313. For example, the card information 324 currently ready for payment slides to the left or the right through a touch-and-drag gesture, such that the card information 324 currently ready for payment disappears. In addition to this method, the card information 324 currently ready for payment may be removed through various gestures.

As shown in FIG. 13b, as the card information 324 currently ready for payment disappears, the additional window 313 is extended by the area occupied by the card information 324 currently ready for payment. When the user inputs a gesture of touching and dragging specific bank information 326 of the card information or the bank information displayed in the list window 312, the specific band information 326 is moved in the direction of the drag gesture and, when a gesture of releasing touch at a specific position, for example, on the additional window 313, the specific bank window 326 may be displayed in the additional window 313.

When a gesture of touching a specific region 325 is input after the specific bank information 326 displayed in the list window 312 is displayed in the additional window, as shown in FIG. 13c, the controller 180 may be connected to the specific bank displayed in the additional window 313 and display a message “The account number is being searched for” on the display unit 151. Here, the specific region 325 may be a region in which a payment request company is displayed, without being limited thereto.

When connection to the specific bank is established, as shown in FIG. 13d, the controller 180 may display the name and account number of the specific bank. For example, Woori bank and the account number of 1000-303-288 may be displayed on a frequently used account number item.

When an addressee account is erroneously selected, as shown in FIG. 13e, the controller 180 may display a message indicating that the payment request company and a company of an account, to which money is transferred, are not identical, thereby preventing the payment amount from being erroneously transferred. For example, when the payment request company is “Elbon” and “Woori bank 1343-132-1299” (installment savings) is erroneously selected as the account, to which money is transferred, the message shown in FIG. 13e may be displayed and a cancel button may be selected by the user.

If the cancel button is selected, the screen shown in FIG. 13 may be displayed. As shown in FIG. 13f, the mobile terminal 100 acquires the account information of the payment request company from the payment terminal 200 and displays the account information on the display unit 151. When the user inputs a gesture of touching the payment request company “Blbon”, as shown in FIG. 13g,′ the controller 180 may display the payment information and the selection information related to payment on the display unit 151.

Since the account number of the payment request company is displayed on the display unit 151, the user may check the account number of the company, to which the payment amount is transferred. After the user performs payment amount confirmation and additional selection, when a request for payment is made through fingerprint authentication of the user, account transfer from the account number of the specific bank added to the additional window 313 into the account number of the company, to which money will be transferred, is finished, thereby finishing payment for the order.

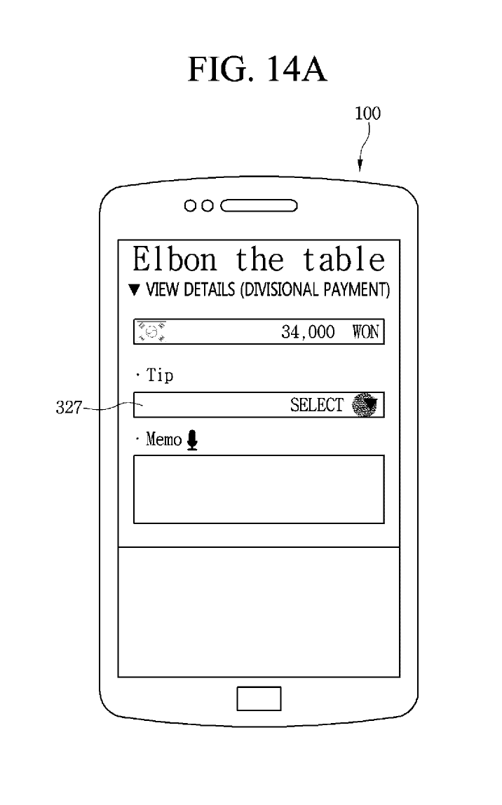

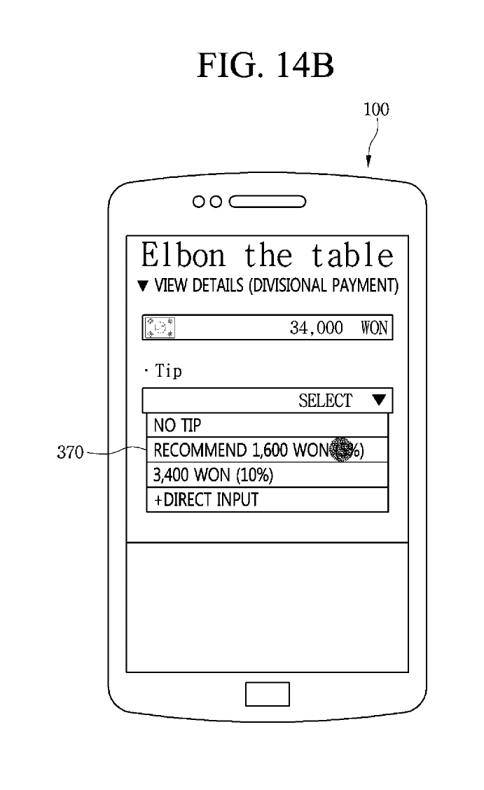

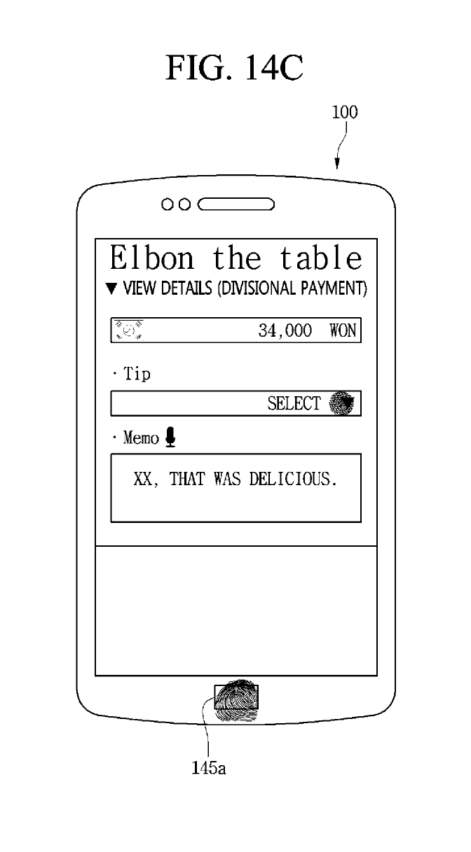

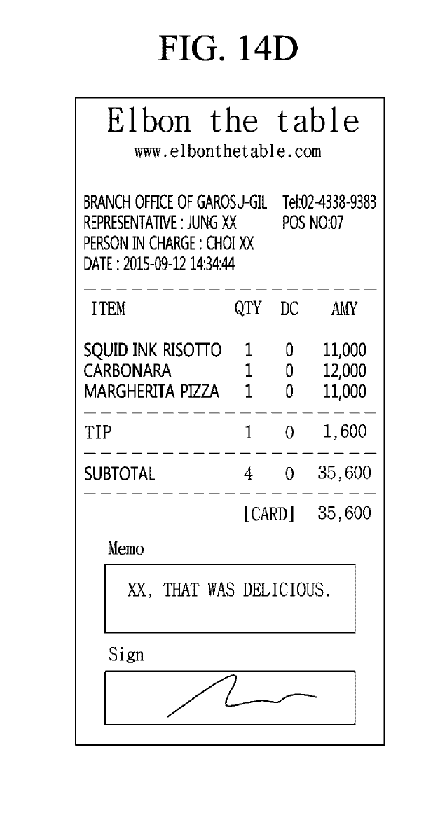

FIG. 14 is a diagram showing screens explaining a method of giving a tip. As shown in FIG. 14a, the controller 180 may display the payment information and the selection information related to payment on the display unit 151. When the user inputs a gesture of touching a tip input window 327, as shown in FIG. 14b, the controller 180 may display a tip related selection menu 370.

The tip related selection menu 370 assists selection of the user and may include a “no tip” menu item, a 5% tip menu item, a 10% tip menu item, and a direct input menu item, without being limited thereto. When the user inputs a gesture of touching one selection menu item from the tip related selection menu 370, as shown in FIG. 14c, the controller 180 may set the selection menu item to a tip amount to be given by the user.

As another example, although not shown, a clerk selection menu item may be displayed near the tip input window 327, a list of the names of the clerks of the company may be displayed when a command for selecting the clerk selection menu item is input, and a command for selecting a specific clerk from the list may be input to tip the specific clerk. Meanwhile, a memo input window may be displayed on the display unit 151, and, when the user inputs a gesture of writing a memo in the memo input window, the controller 180 may set the memo written by the user and display the memo in the memo input window.

Thereafter, when the user inputs the fingerprint thereof through the finger scan sensor 145a, the controller 180 may perform fingerprint authentication based on the input fingerprint and transmit a payment approval request to the payment terminal 200 to make and finish payment by the payment terminal 200 when fingerprint authentication succeeds.

As shown in FIG. 14d, when payment is finished to issue a receipt, the ordered items, the payment amount of each item, a tip amount and the memo input in the memo input window may be displayed on the receipt. In addition, the signature connected to the fingerprint of the user may be displayed on the receipt. The signature may be preconfigured to match the fingerprint. In this case, payment may be made using fingerprint authentication without the signature. This will be described below in detail.

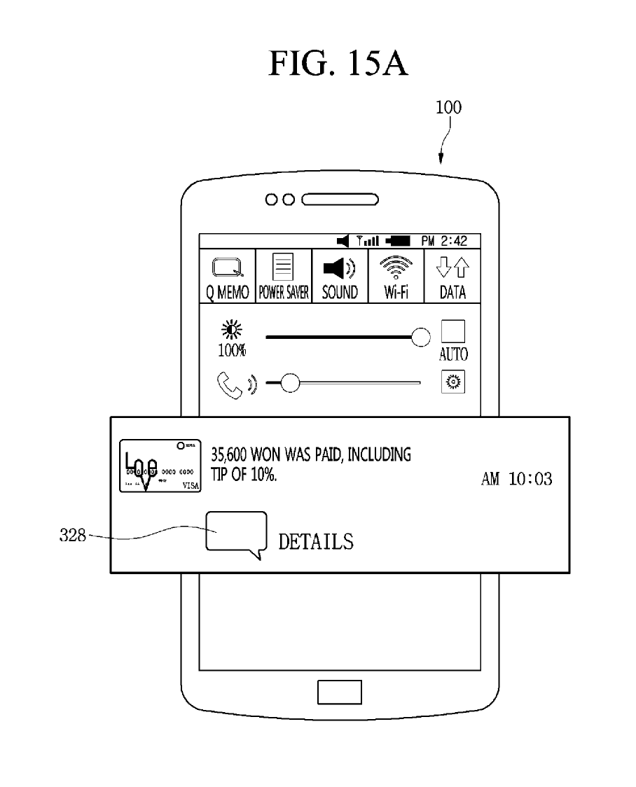

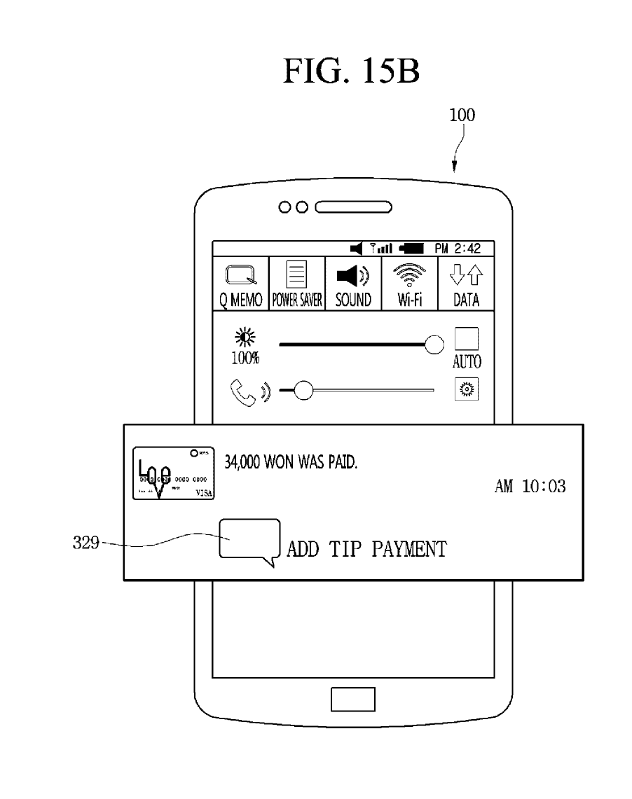

FIG. 15 is a diagram showing screens explaining a method of giving a tip when the tip is missed upon payment. If payment is finished after finishing selection of the selection menu 370 shown in FIG. 14b, as shown in FIG. 15a, the controller 180 may display a message indicating that payment including a tip is finished on the display unit 151.

Specifically, if payment is finished after finishing selection of the selection menu 370 shown in FIG. 14b, the controller 180 may transmit a payment request to the payment terminal 200, and the payment terminal 200 may finish payment in response to the payment request and then transmit payment finish information including a tip to the mobile terminal 100 in response to the payment request. In this case, the controller 180 of the mobile terminal 100 may display a message indicating that payment including a tip is finished on the display unit 151 based on the payment finish information.

When a gesture of touching a details item 328 displayed in the message is input, the controller 180 may display detailed payment information related to payment, for example, each ordered item, a payment amount of each item, a tip amount and a parking fee, such that the user easily checks detailed payment information. When payment is finished without selection of the tip related selection menu 370 shown in FIG. 14b, as shown in FIG. 15b, the controller 180 may display a message indicating that payment is finished and including a tip addition payment item on the display unit 151.

Specifically, if payment is finished after finishing selection of the tip related selection menu 370 shown in FIG. 14b, the controller 180 may transmit the payment request to the payment terminal 200, and the payment terminal 200 may finish payment in response to the payment request and then transmit payment finish information including information indicating that a tip is not given to the mobile terminal 100. In this case, the controller 180 of the mobile terminal 100 may display a message indicating that payment is finished and including the tip addition payment item 329 on the display unit 151 based on the payment finish information.

When the user inputs a gesture of touching the tip addition payment item 329, the controller 180 may display the tip related selection menu 370 shown in FIG. 14b and enable the user to select one menu item of the tip related selection menu 370 to give a tip anytime even when the user does not give the tip upon payment.

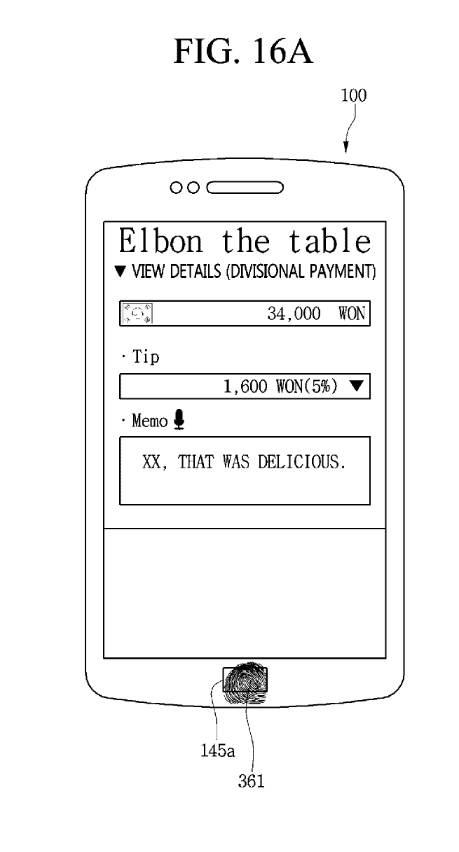

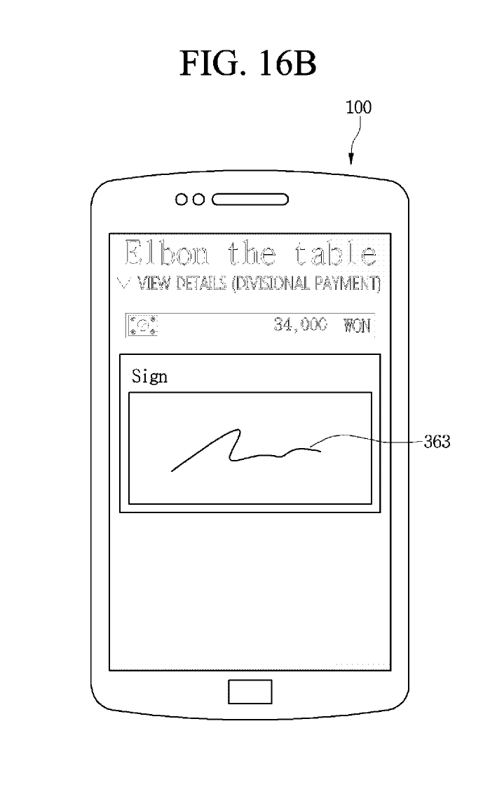

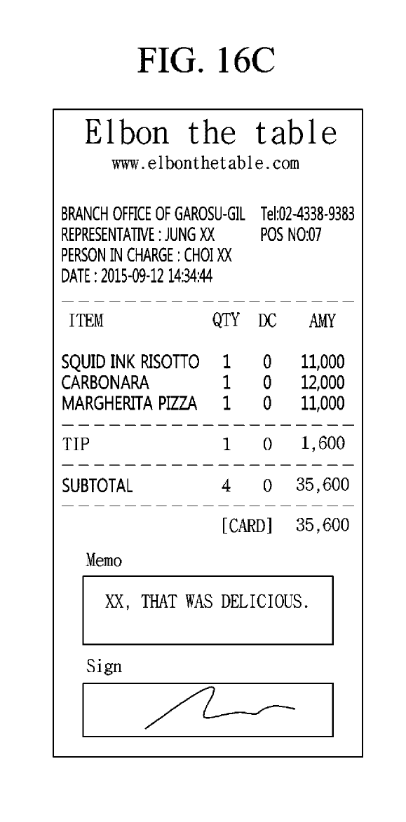

FIG. 16 is a diagram showing screens explaining a method of signing a signature through a fingerprint. As shown in FIG. 16a, after the user inputs, approves or selects selection information, the fingerprint 361 of the user may be input through the finger scan sensor 145a for a payment request.

When the fingerprint 318 of the user is input, as shown in FIG. 16b, the controller 180 may perform fingerprint authentication, transmit a payment request to the payment terminal 200 when fingerprint authentication succeeds, and display a signature 363 corresponding to the fingerprint of the user on the display unit 151.

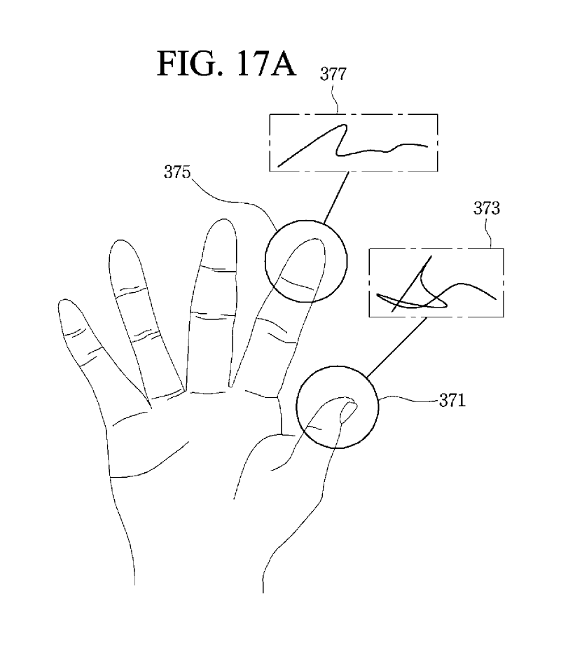

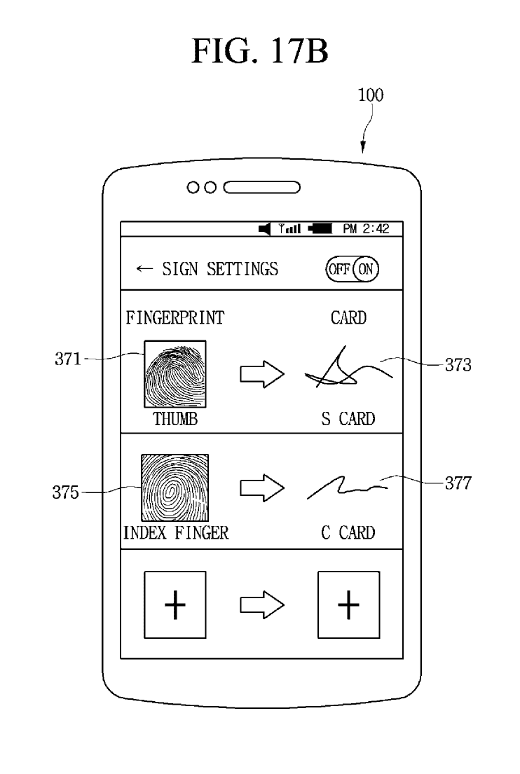

As shown in FIG. 17a, different fingers of the user may be registered with the mobile terminal 100 as the fingerprint. As shown in FIG. 17b, when the fingerprint of the user is registered, the signature connected to the fingerprint may be registered. For example, when the fingerprint 371 of a thumb is registered, a first signature 373 corresponding to the fingerprint 371 of the thumb may also be registered. For example, the fingerprint 371 of the thumb and the first signature 373 may be used upon making payment using a first card. Accordingly, the first signature 373 may be displayed on the receipt of the first card.

For example, when the fingerprint 375 of an index finger is registered, a second signature 377 corresponding to the fingerprint 375 of the index finger may also be registered. For example, the fingerprint 375 of the index finger and the second signature 377 may be used upon making payment using the second card 377. Accordingly, the second signature 377 may be displayed on the receipt of the second card. Although two fingerprints and signatures corresponding thereto are registered for convenience in the figure, two or more fingerprints and signatures corresponding thereto may be registered.

The signatures corresponding to different fingerprints may be different from or equal to each other. For example, the signatures corresponding to the first fingerprint and the second fingerprint may be equal. For example, the first signature corresponding to the first fingerprint and the second signature corresponding to the second fingerprint may be different from each other. At least one fingerprint and at least one signature corresponding thereto may be registered and used upon making payment using a card, thereby increasing card security.

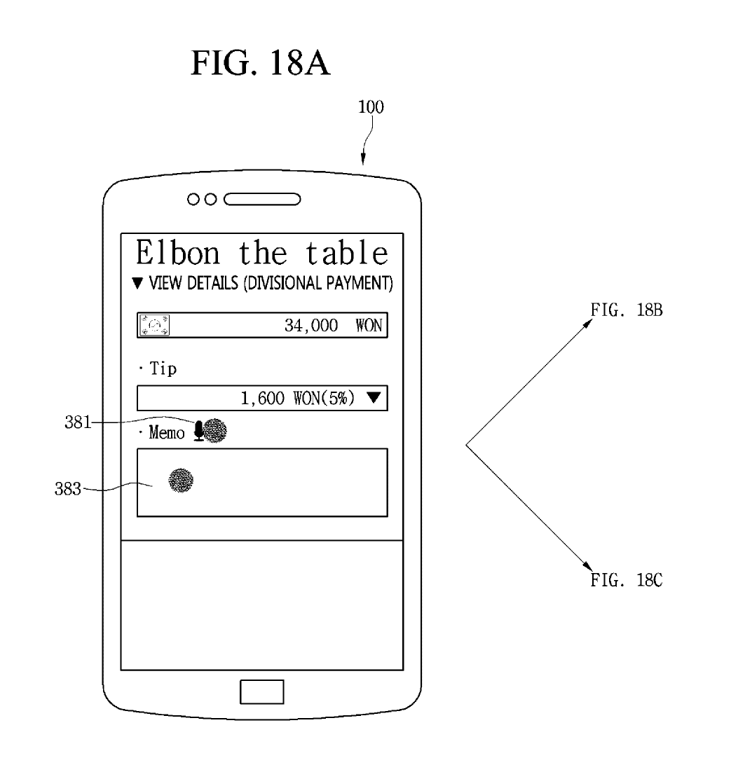

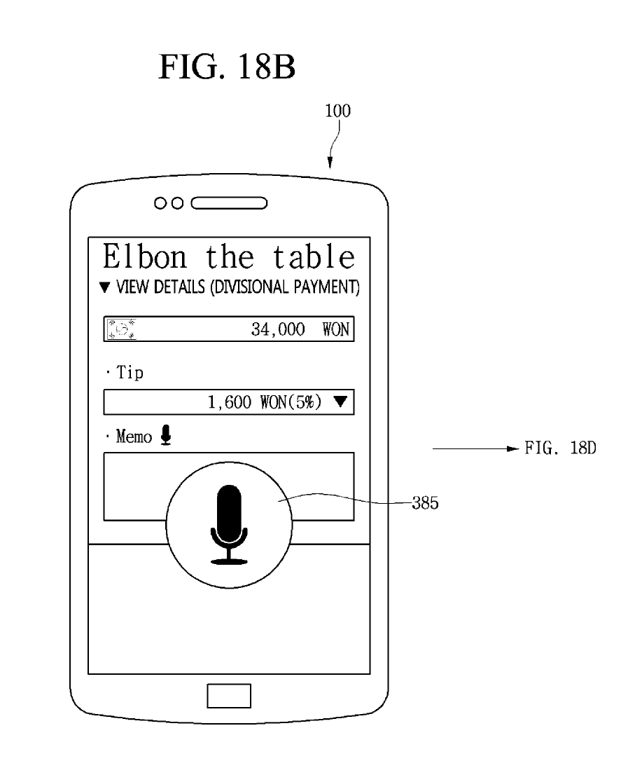

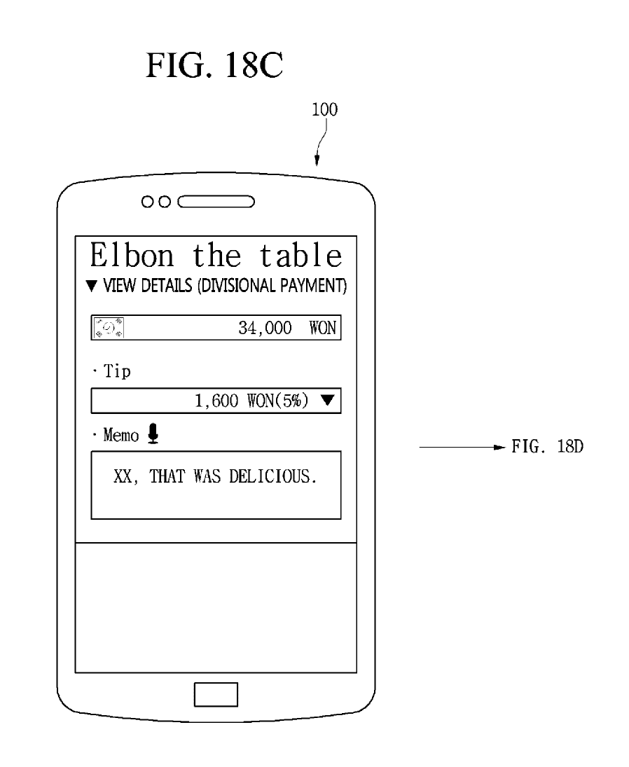

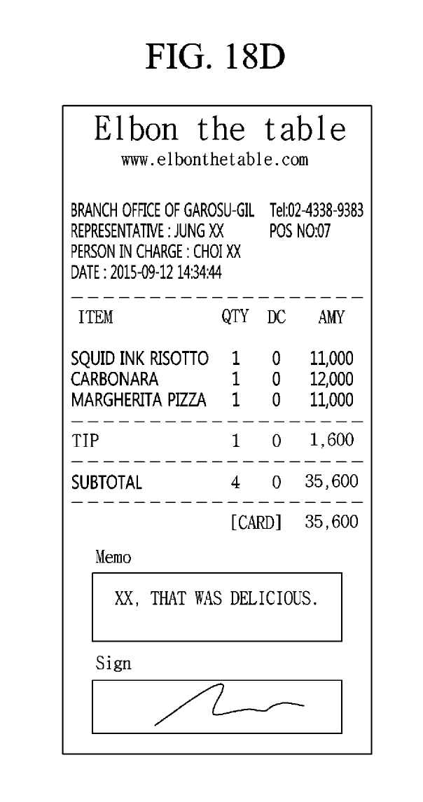

FIG. 18 is a diagram showing screens explaining a method of inputting a memo. As shown in FIG. 18a, the controller 180 may display the payment information and the selection information related to payment on the display unit 151. As selection information, memo information may be displayed. The memo information may include a microphone object 381 and/or a memo input window 383.

When the user inputs a gesture of touching a microphone object 381, as shown in FIG. 18b, the controller 180 may display a mic activation object 385 to indicate that the user is prepared to record their voice. When user's voice is input, the controller 180 may record the input voice and store a voice recording file in the memory. Thereafter, the stored voice recording file may be transmitted to the payment terminal 200 along with the payment request, a voice recording file button may be displayed on the screen of the payment terminal 200 upon finishing payment at the payment terminal 200, and the voice is played back when the voice recording file button is selected.

When the user inputs a gesture of touching the memo input window 383, the controller 180 may display an alphanumeric keyboard. When the user inputs a gesture of touching the alphanumeric key, as shown in FIG. 18c, the controller 180 may display a memo including letters, numbers and/or symbols of the alphanumeric keyboard selected by the touch gesture and store the memo in the memory. Thereafter, the stored memo may be transmitted to the payment terminal 200 along with the payment request and, when payment is finished at the payment terminal 200 to issue a receipt, as shown in FIG. 18d, the memo input by the user may be displayed on the receipt along with the payment amount and the signature.

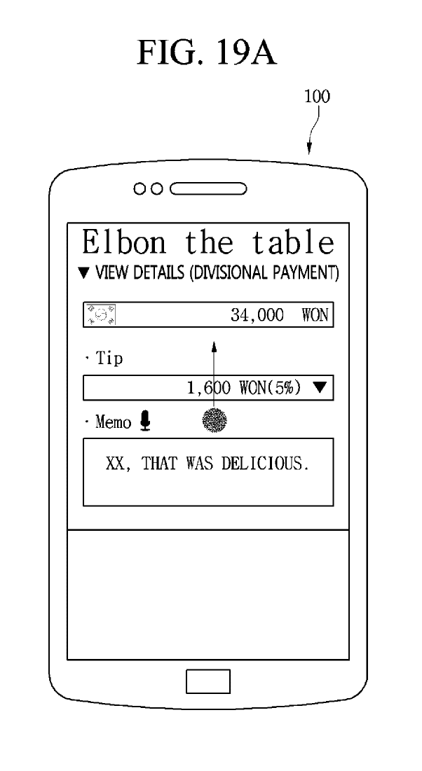

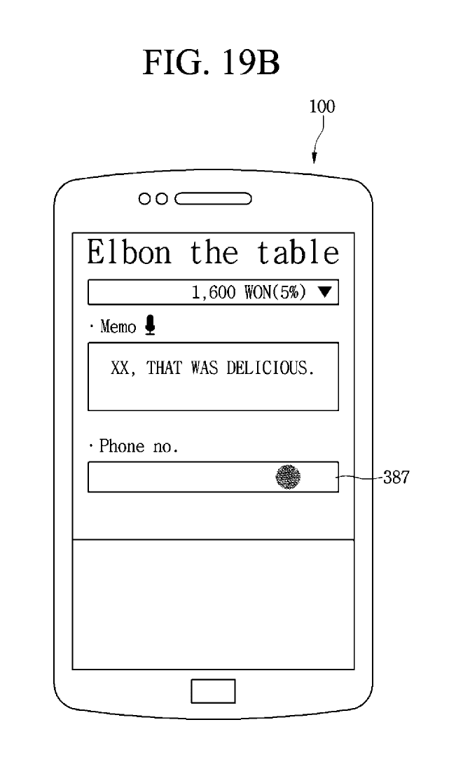

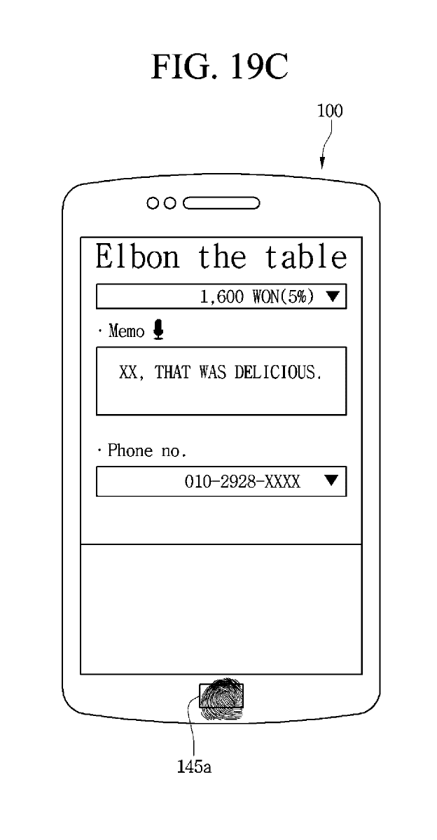

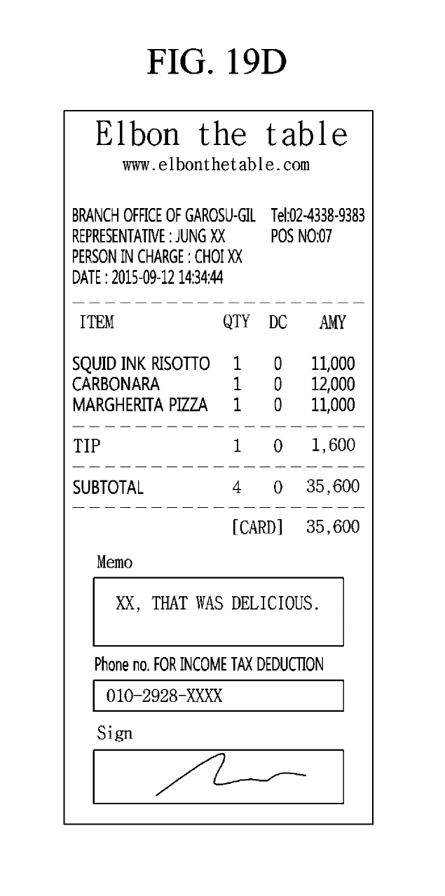

FIG. 19 is a diagram showing screens explaining a method of inserting a cellular phone number into a receipt. As shown in FIG. 19, the controller 180 may display the payment information and the selection information related to payment on the display unit 151. When the user inputs a gesture of touching and dragging a specific region on the screen of the display unit 151, as shown in FIG. 19b, the controller 180 may slide in a cellular phone number input window 387 instead of disappearing of the currently displayed selection information in the drag direction, e.g., from bottom to top. Here, the specific region may be any region of the screen.

When the user inputs a gesture of touching the cellular phone input window 387, the controller 180 may display the numeric keyboard. When the user inputs a cellular phone number using the numeric keyboard, as shown in FIG. 19c, the cellular phone number may be displayed in the cellular phone input window 387.

Thereafter, when the fingerprint of the user is input through the finger scan sensor 145a, fingerprint authentication may be performed and, when fingerprint authentication succeeds, the payment request may be transmitted to the payment terminal 200 along with the cellular phone number information of the user, such that payment is finished by the payment terminal 200 to issue a receipt. At this time, as shown in FIG. 19d, the cellular phone number of the user may be displayed on the receipt along with the payment amount and the signature. The clerk of the payment terminal 200 may perform an income tax income tax deduction procedure using the cellular phone number of the payment terminal 200.

Since the cellular phone number of the user is personal information and thus security thereof should be ensured, the cellular phone number of the user is not displayed on the receipt and instead may disappear after being displayed on the screen of the payment terminal 200 for a predetermined time, e.g., 1 minute. Accordingly, the security of the cellular phone number of the user as personal information may be enhanced.

Meanwhile, if the cellular number input window 387 is linked to the cellular phone number of the user, when a gesture of touching the cellular phone number input window 387 is input, the cellular phone number may be read from the memory and displayed on the cellular phone number input window 387. Accordingly, the user does not need to input the cellular phone number thereof, thereby increasing user convenience.

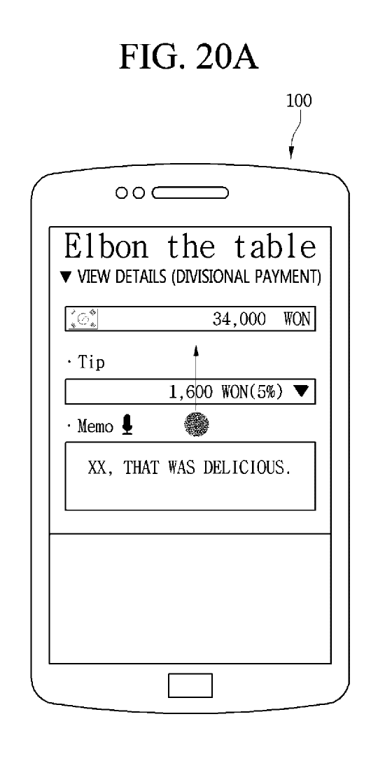

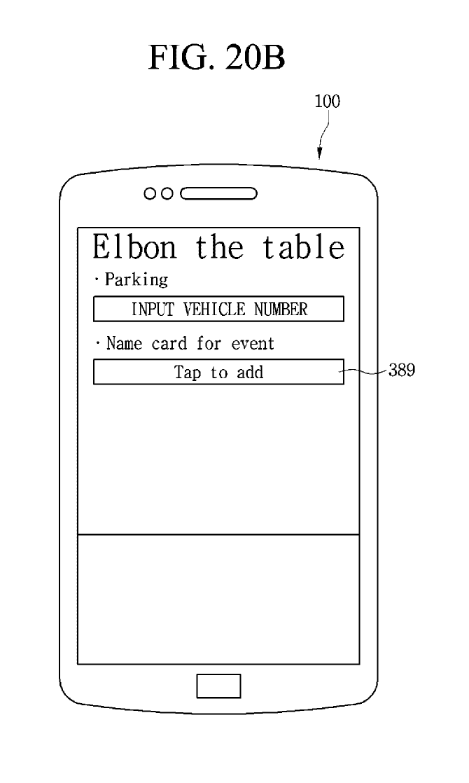

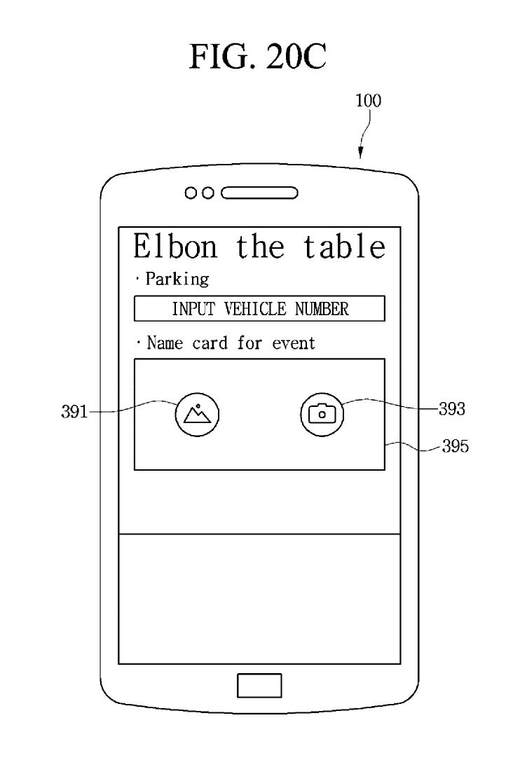

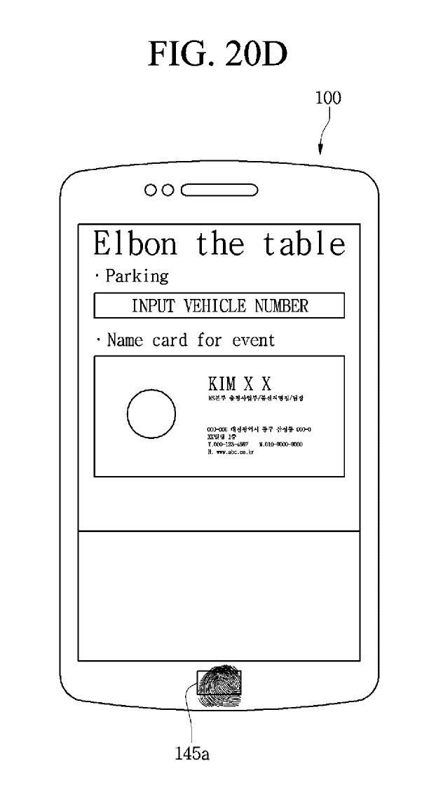

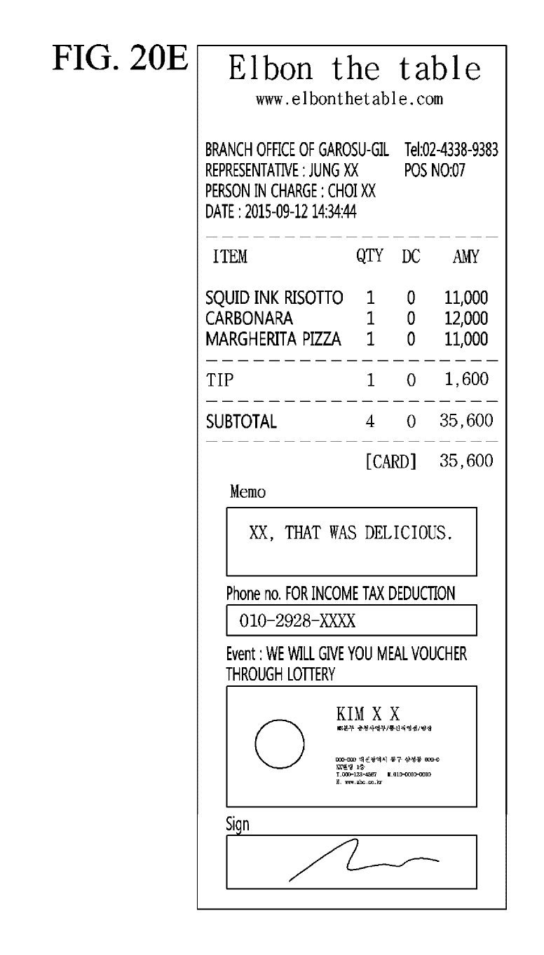

FIG. 20 is a diagram showing screens explaining a method of inserting a business card into a receipt for participation in an event. As shown in FIG. 20a, the controller 180 may display the payment information and the selection information related to payment on the display unit 151.

When the user inputs a gesture of touching and dragging a specific region on the screen of the display unit 151, as shown in FIG. 20b, the controller 180 may slide in a business card addition item 389 instead of disappearing of the currently displayed selection information in the drag direction, e.g., from bottom to top. Here, the specific region may be any region of the screen.

When the user inputs a gesture of touching the business card addition item 389, as shown in FIG. 20c, the controller 180 may display a window 935 including a photo icon 391 or a camera icon 393. When the user inputs a gesture of touching the photo icon 391, a photo folder may be opened, and, when the user selects a business card image previously registered with the photo folder, as shown in FIG. 20d, the business card image may be displayed instead of the business card addition item 389.

If the user does not register the business card with the photo folder, the camera may be activated when the user inputs the gesture of touching the camera icon 393 and the business card of the user may be photographed using the camera and registered with the photo folder.

Meanwhile, when the user inputs the fingerprint thereof through the finger scan sensor 145a, fingerprint authentication may be performed and, when fingerprint authentication succeeds, the payment request may be transmitted to the payment terminal 200 along with the business card information, such that payment is finished by the payment terminal 200 to issue a receipt. At this time, as shown in FIG. 20e, the business card of the user may be displayed on the receipt along with the payment amount and the signature. The company may hold a lottery event based on the business card displayed on the receipt.

Accordingly, the business card registered with the mobile terminal 100 may be sent to the payment terminal 200 to be inserted into the receipt, such that the user does not need to input the business card thereof into the event box of the company offline for the lottery event.

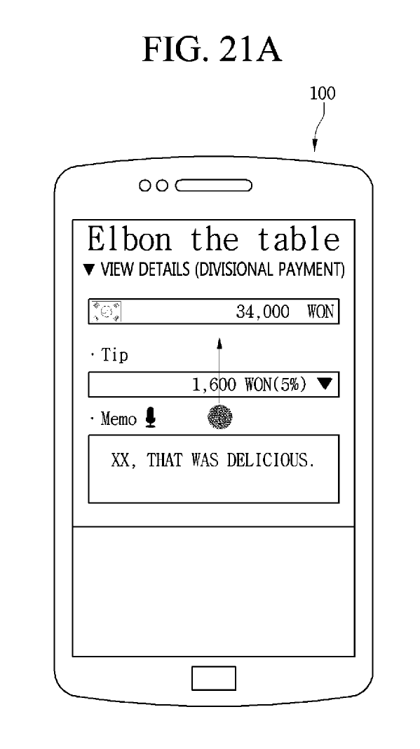

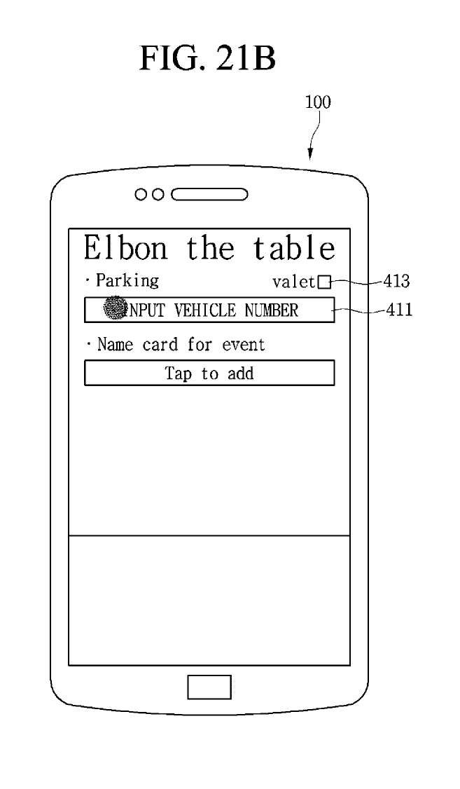

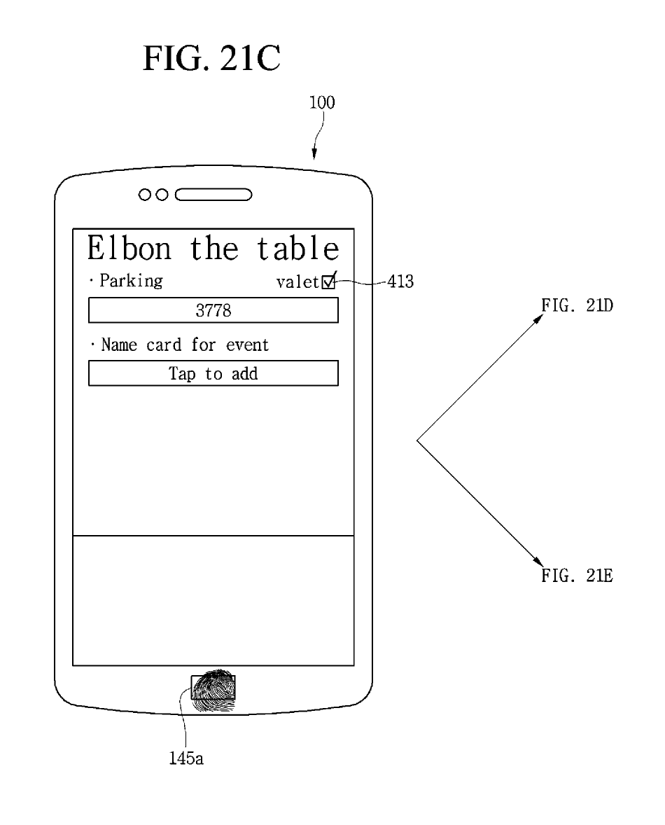

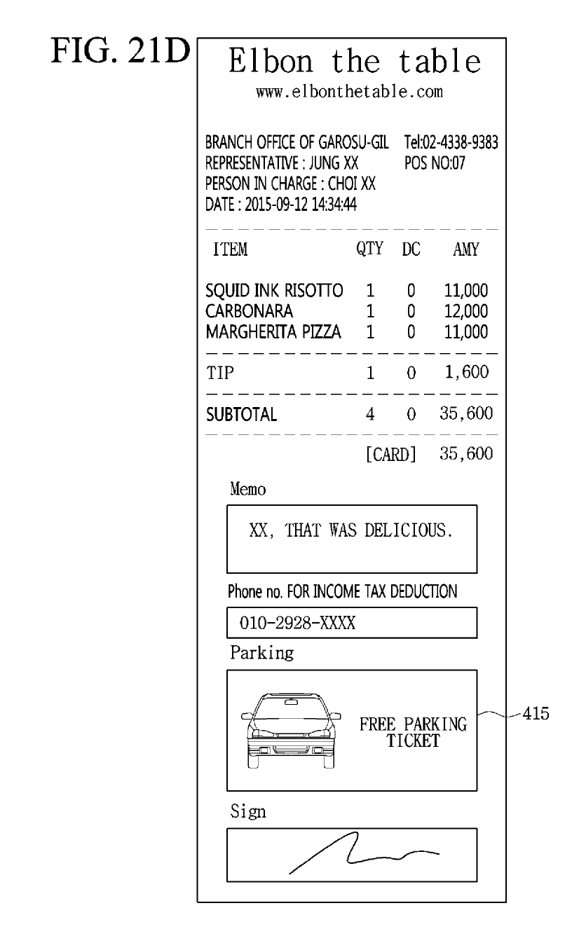

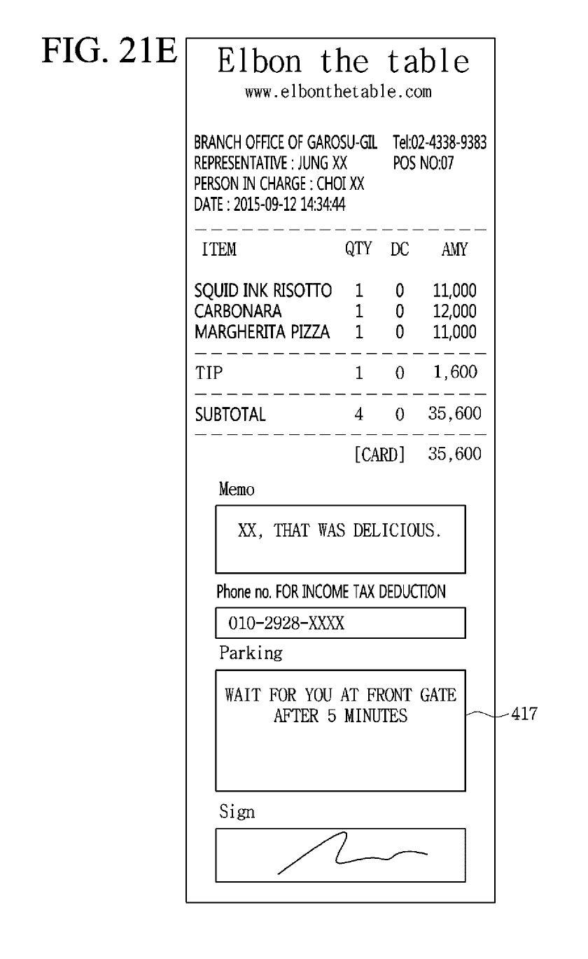

FIG. 21 is a diagram showing screens explaining a method of paying a parking fee. As shown in FIG. 21a, the controller 180 may display the payment information and the selection information related to payment on the display unit 151.

When the user inputs a gesture of touching and dragging a specific region on the screen of the display unit 151, as shown in FIG. 21b, the controller 180 may slide in a vehicle number input window 411 and a valet packing check item 413 instead of disappearing of currently displayed selection information in the drag direction, for example, from bottom to top.

When the user inputs a gesture of touching the vehicle number input window 411, the controller 180 may display an alphanumeric keyboard and, when a gesture of touching the alphanumeric keyboard to input a vehicle number is input, as shown in FIG. 21c, the controller 180 may display the vehicle number in the vehicle number input window 411.

When the user directly parks the vehicle, the valet parking check item 413 may not be selected. In this case, fingerprint is input through the finger scan sensor 145a and, when fingerprint authentication succeeds, the payment request may be transmitted to the payment terminal 200 along with parking related information, that is, a vehicle number and valet parking check information. The payment terminal 200 may pay the parking fee based on the parking related information. For example, if the valet parking check item 413 is not selected, the payment terminal 200 may receive the parking time of the vehicle of the user, settle the parking fee corresponding to the parking time of the vehicle of the user, and display the parking fee information on a receipt.

If the user directly parks the vehicle, the parking lot permits free parking for 2 hours and the vehicle of the user is parked for less than 2 hours, the payment terminal 200 may display a free parking ticket indicating free parking on the receipt issued by the payment terminal 200 as shown in FIG. 21d, instead of paying the parking fee.

When the parking time of the vehicle of the user exceeds 2 hours, the payment terminal 200 may process payment for the parking fee corresponding to the extra time and display parking fee information 415 on the receipt. If the user directly parks the vehicle and the parking lot always permits free parking, the payment terminal 200 may display a free parking ticket indicating free parking on the receipt issued by the payment terminal 200 instead of paying the parking fee.

If the vehicle of the user is valet parked and the valet parking selection item is selected, the payment request may be transmitted to the payment terminal 200 through fingerprint authentication, along with parking related information, that is, the vehicle number and the valet parking check information. The payment terminal 200 may settle the parking fee based on the parking related information and issue a receipt to display a message 417 indicating when and where the valet parked vehicle waits as shown in FIG. 21e. As described above, since the parking fee is pre-paid, the user does not pay the parking fee of the vehicle thereof offline, thereby increasing user convenience.

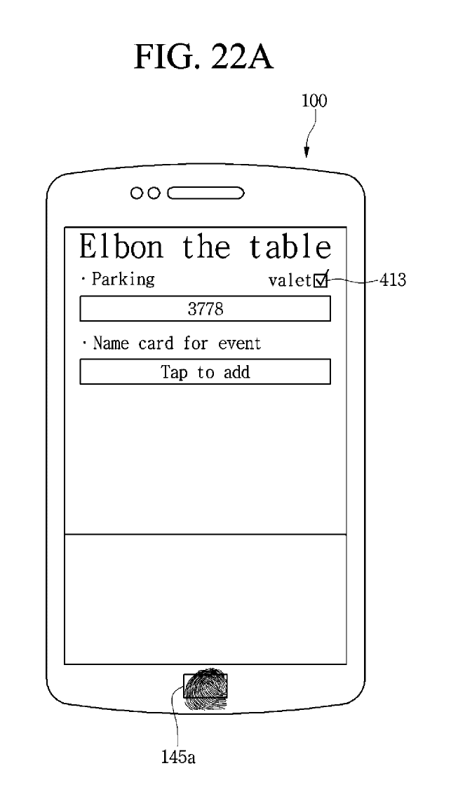

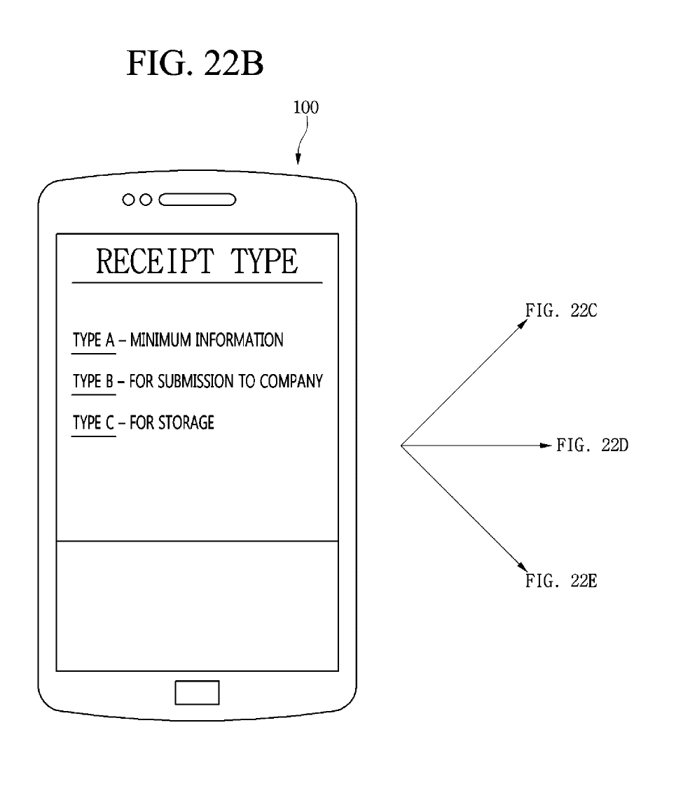

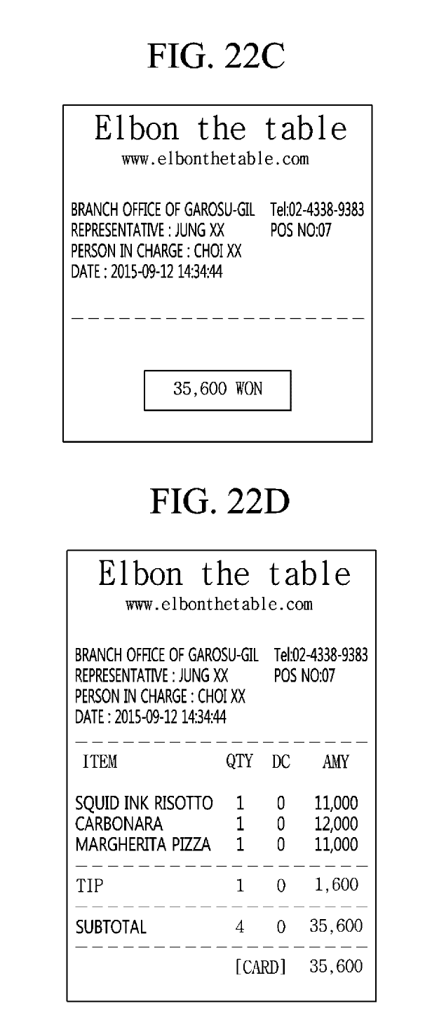

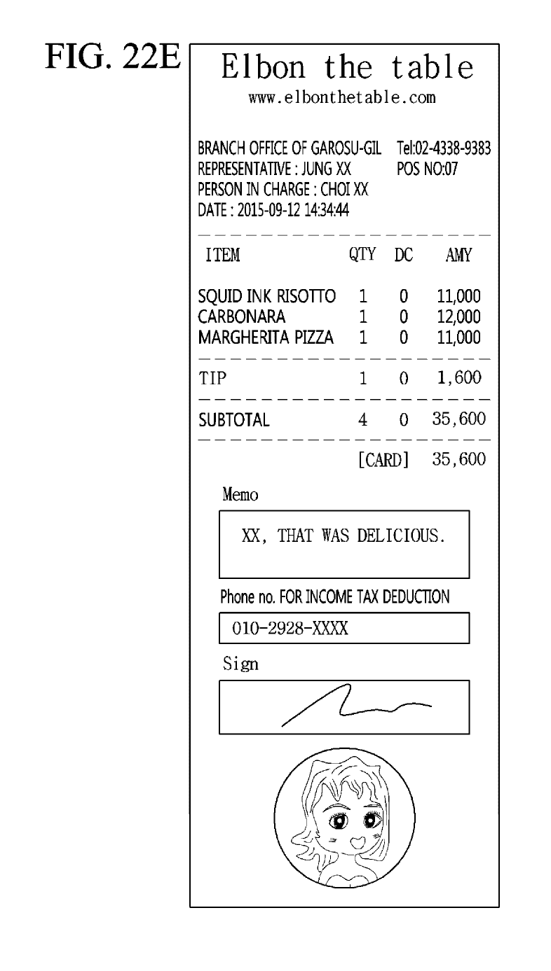

FIG. 22 is a diagram showing screens explaining a method of selecting various types of receipts. As shown in FIG. 22a, fingerprint authentication may be performed after selection information is processed by the user. When fingerprint authentication succeeds, before the payment request is transmitted to the payment terminal 200, as shown in FIG. 22b, type information of a receipt to be output from the payment terminal 200 may be displayed.

The receipt type may include a type A for outputting only minimum information, a type B for outputting a receipt for submission to a company and a type C for outputting a receipt for storage and may include various types according to the purposes and characteristics of the receipt.

When the user selects the type A, the payment request may be transmitted to the payment terminal 200 along with selection information of the type A and the receipt shown in FIG. 22c may be output from the payment terminal 200. That is, food menus, the amount of food, price information of each menu item, a memo, a phone number, parking display and signature display may be omitted and only the price information may be output on the receipt, according to selection of type A.

When the user selects type B, the payment request may be transmitted to the payment terminal 200 along with selection information of type B and the receipt shown in FIG. 22d may be output from the payment terminal 200. That is, since the receipt will be submitted to the company according to selection of type B, a receipt, from which information related to the user, that is, a memo, a phone number, parking display and signature display are omitted, may be output.

When the user selects type C, the payment request may be transmitted to the payment terminal 200 along with selection information of type C and the receipt shown in FIG. 33e may be output from the payment terminal 200. That is, since the receipt will be stored by the user according to selection of type C, user information such as caricatures of the user indicating the receipt of the user may be output on the receipt. The caricatures of the user may be stored in the mobile terminal 100 and may be transmitted when the payment request is transmitted to the payment terminal 200. The payment terminal may output the receipt including the caricatures of the user received from the mobile terminal 100. The present invention can output various types of receipts according to the purposes or characteristics of the receipt, thereby increasing user convenience.

The present invention mentioned in the foregoing description may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

The mobile terminal of the present invention is applicable to any place where payment is made, such as supermarkets, department stores, restaurants, accommodations, and public transportation.

1-20. (canceled)

21. A mobile terminal comprising:
an input unit;
a display unit;
a short-range communication unit; and
a controller configured to:
wirelessly communicate, via the short-range communication unit, with a payment terminal for making a payment using the mobile terminal,
display user-settable payment information on the display unit related to making the payment using the mobile terminal, and
in response to selection of the user-settable payment information, transmit the selected user-settable payment information to the payment terminal for making the payment via the short-range communication unit.

22. The mobile terminal according to claim 21, wherein the user-settable payment information includes at least one of a change in an amount of the payment, a tip to leave in addition to the payment, card divisional payment information indicating multiple cards to be used to make the payment, divisional user payment information indicating multiple users to make the payment, country currency selection information, memo input information, signature input information connected with fingerprint information, and parking related information.

23. The mobile terminal according to claim 22, wherein the user-settable payment information includes a first set of user-settable payment items when the mobile terminal is located at a first place, and the user-settable payment information includes a second set of user-settable payment items when the mobile terminal is located at a second place different than the first place.

24. The mobile terminal according to claim 23, wherein, when the first place corresponds to a restaurant, the first set of user-settable payment items include at least one of the tip to leave and the parking related information, and when the second place corresponds to a transportation station, the second set of user-settable payment items include at least one of a type of transportation and a number of passengers for the type of transportation.

25. The mobile terminal according to claim 21, wherein the controller is further configured to:
display a card image on the display unit indicating a payment card to be used to make the payment, and
display the user-settable payment information in response to a touch and drag of a status bar area on the display unit or in response to a touch and drag of a payment queue on the display unit.

26. The mobile terminal according to claim 22, wherein the controller is further configured to:
in response to a selection of a first country currency to be used to make the payment, display at least a second county currency that can be used to make the payment, and an amount of the first country currency that would be charged to the card for the second country currency.

27. The mobile terminal according to claim 21, wherein the controller is further configured to:
display a payment amount window for making the payment,
activate the payment amount window to modify an amount of the payment in response to a selection of the payment amount window, and
display a drum wheel object on the display unit for changing the amount of the payment when the payment amount window is activated.

28. The mobile terminal according to claim 27, wherein the drum wheel object includes a plurality of currency country names and an amount modifiable based on the payment amount.

29. The mobile terminal according to claim 21, wherein the user-settable payment information changes according to a place where the mobile terminal is located.

30. The mobile terminal according to claim 21, wherein the controller is further configured to:
execute a household-ledger application before making the payment, and
display a result of determining whether an amount of the payment exceeds a limit included for a specific item in the household-ledger application.

31. The mobile terminal according to claim 30, wherein, when the amount of payment exceeds the limit, display an option on the display unit for diverting the payment to another item included in the household-ledger application.

32. The mobile terminal according to claim 21, wherein the controller is further configured to:
display a list including a plurality of items on the display unit, and
in response to a selection of at least one item of the plurality of items, transmit a request for paying a remainder of an unselected item of the plurality of items to a third party via a wireless communication unit.

33. The mobile terminal according to claim 22, wherein, when a first card displayed as first card information exceeds a limit, the controller is further configured to add at least one second card as second card information for divisional payment.

34. The mobile terminal according to claim 33, wherein the controller is further configured to:
display an amount adjustment bar on a boundary between the first card information and the second card information, and
change an interval of each of the first card information and the second card information in correspondence with a movement of the amount adjustment bar in order to adjust payment amount of each of the first card information and the second card information.

35. The mobile terminal according to claim 21, wherein the controller is further configured to:
display bank information instead of the first card information, and
transmit a payment request to the payment terminal using account information included in the bank information.

36. The mobile terminal according to claim 21, wherein the controller is further configured to register fingerprints corresponding to different fingers.

37. The mobile terminal according to claim 21, wherein the controller is further configured to transmit a payment request to the payment terminal along with vehicle number information when a vehicle number is input to pay a parking fee.

38. A method of controlling a mobile terminal, the method comprising:
wirelessly communicating, via a short-range communication unit, with a payment terminal for making a payment using the mobile terminal;
displaying user-settable payment information on a display unit of the mobile terminal related to making the payment using the mobile terminal; and
in response to selection of the user-settable payment information, transmitting the selected user-settable payment information to the payment terminal for making the payment via the short-range communication unit.

39. The method according to claim 38, wherein the user-settable payment information includes at least one of a change in an amount of the payment, a tip to leave in addition to the payment, card divisional payment information indicating multiple cards to be used to make the payment, divisional user payment information indicating multiple users to make the payment, country currency selection information, memo input information, signature input information connected with fingerprint information, and parking related information.

40. The method according to claim 39, wherein the user-settable payment information includes a first set of user-settable payment items when the mobile terminal is located at a first place, and the user-settable payment information includes a second set of user-settable payment items when the mobile terminal is located at a second place different the first place.
